(19) United States
(12) Patent Application Publication
(10) Pub. No.: US 2023/0308176 A1
(43) Pub. Date: Sep. 28, 2023

(54) Improved scheduling for interference handling in optical wireless communications systems

(71) Applicants: SIGNIFY HOLDING B.V., EINDHOVEN (NL); KATHOLIEKE UNIVERSITEIT LEUVEN, Leuven (BE)

(72) Inventors: Andries VAN WAGENINGEN, Wijlre (NL); Jona BEYSENS, Leuven (BE); Johan-Paul Marie Gerard LINNARTZ, Eindhoven (NL)

(21) Appl. No.: 18/020,129

(22) PCT Filed: Aug. 5, 2021
(86) PCT No.: PCT/EP2021/071864

§ 371 Date: Feb. 7, 2023

(30) Foreign Application Priority Data
Aug. 11, 2020 (EP) 20190500.7

(51) Int. Cl. H04B 10/079; H04B 10/116

(52) U.S. Cl. CPC H04B 10/07953; H04B 10/116

(57) ABSTRACT

This invention proposes a mechanism to improve system performance in an optical wireless communication system by examining whether time slots in time channels are to be scheduled for exclusive use or could be utilized for parallel communication. The examination is based on a cross-over point from tolerating interference to applying time division. A reserved period for each access point is defined within its assigned time channel, which is exclusively reserved for communication with its endpoint(s). This reduces the communication overhead and keeps freedom of adapting slot-scheduling in the exclusive period at the cost of some performance reduction. To minimize this performance reduction, the size of the reserved period can be adapted to the actual need based on the traffic demand for exclusive use and non-exclusive use.

### FIELD OF THE INVENTION

The invention relates to the field of communication in optical wireless networks, such as—but not limited to—Li-Fi networks, for use in various different applications for home, office, retail, hospitality and industry.

### BACKGROUND OF THE INVENTION

Optical wireless networks, such as Li-Fi networks (named like Wi-Fi networks), enable mobile user devices (called end points (EP) in the following) like laptops, tablets, smartphones or the like to connect wirelessly to the internet. Wi-Fi achieves this using radio frequencies, but Li-Fi achieves this using the visible and non-visible light spectrum (including ultraviolet (UV) and infrared (IR) light) which can enable unprecedented data transfer speed and bandwidth. Furthermore, it can be used in areas susceptible to electromagnetic interference.

Based on the modulations, the information in the coded light can be detected using any suitable light sensor. This can be a dedicated photocell (point detector), an array of photocells possibly with a lens, reflector, diffuser of phosphor converter, or a camera comprising an array of photocells (pixels) and a lens for forming an image on the array. E.g., the light sensor may be a dedicated photocell included in a dongle which plugs into the end point a dedicated light sensor integrated in the end point, a general purpose (visible or infrared light) camera of the end point, or an infrared detector initially designed for instance for 3D face recognition having a dual-use. Either way this may enable an application running on the end point to receive data via the light.

A communication signal can be embedded in a light signal emitted by an illumination source of an access device, such as an everyday luminaire, e.g. room lighting or outdoor lighting, thus allowing use of the illumination from the luminaires as a carrier of information. The light thus comprises both a visible illumination contribution for illuminating a target environment such as a room (typically the primary purpose of the light), and an embedded signal for providing information into the environment (typically considered a secondary function of the light). In such cases, the modulation may typically be performed at a high enough frequency to be beyond human perception, or at least such that any visible temporal light artefacts (e.g. flicker and/or strobe artefacts) are weak enough and at sufficiently high frequencies not to be noticeable or at least to be tolerable to humans. Thus, the embedded signal does not affect the primary illumination function, i.e., so the user only perceives the overall illumination and not the effect of the data being modulated into that illumination. Alternatively, a light signal may be emitted by a dedicated access point having a primary communication function and possibly no second function.

As already mentioned above, such communication signals may also utilize light signals outside the visible spectrum. Outside the visible spectrum in particular the IR or UV range are interesting candidates as these are not visible and thus do not cause visible artefacts; which may be particularly relevant for transmissions originating from handheld devices.

In the following, the term “access point” (AP) is used to designate a logical access device that can be connected to one or more physical access devices (e.g. transceivers). The logical access device may comprise a MAC (Media Access Control) protocol and modulator/demodulator (MODEM) functionality. This means that the physical access devices can be regarded as “optical antenna's”, or optical-electrical converters with associated electronics.

Such physical access devices may typically be located at a luminaire and the logical access point may be connected to one or more physical access devices each located at one or more luminaires. However, compared to RF technology, the range of each access point is smaller, allowing a higher density of access devices. Although the logical access device and the one or more physical access devices may be separate, they may also be co-located in a single device. The physical access devices may be directional, to control their coverage and to achieve a degree of interference mitigation in the spatial domain.

Where coverage areas of neighboring APs overlap, interference of communications between APs and EPs can occur. In optical wireless communication networks, interference handling can be achieved by applying time division multiple access (TDMA) not only within one cell (multiple EPs sharing a common AP) but also among APs with overlapping coverage areas. The aim thereby is to apply time division as soon as an EP associated to a local AP detects that it is in the coverage area of a neighboring AP. When an EP is in the overlapping coverage area, it receives advertisements from both APs and reports to the local AP (to which it is associated) the detection of the neighbor AP.

US2019/0028193 A1 relates to an optical wireless communication system and discloses a method of allocating transmission time slots in such a system. Resources are allocated taking account of asymmetry of interference diagrams on uplink and downlink and adopting reuse of transmission intervals for each channel, in areas in which there is no interference.

WO2020/104288 A1 discloses a wireless optical network with multiple coordinators or other access points, wherein the coverage area of coordinators may overlap. Interference in the communication between coordinators and devices may occur in these overlapping coverage areas. The application proposes an automatic allocation of reserved time slots to coordinators that allow the coordinators to advertise their presence without interference and enable a device to detect the presence of a neighbor coordinator in a single MAC cycle. Cooperation of coordinators can be supervised by a global controller to determine non-interfering time schedules whereby the coordinators rely on interference reports from the devices in the overlapping coverage areas.

### SUMMARY OF THE INVENTION

However, the above conventional time division approach neglects that interference may be tolerated if the EP detects to be in the coverage area of a neighboring AP. This means that the system may apply time division too aggressively in such situation, leading to a lower performance resulting from interference avoidance as compared to interference tolerance. Moreover, the above conventional time division approach does not lead to optimal performance when too many time slots are reserved for exclusive use, which could have been utilized for non-exclusively use otherwise.

It is an object of the present invention to provide a more flexible approach for interference handling in optical wireless networks.

This object is achieved by a system as claimed in claim 1, by an endpoint as claimed in claim 2, by an access point as claimed in claim 6 or 7, and by a network controller as claimed in claim 8.

According to a first aspect, a system for controlling communication for interference handling in an optical wireless communication network is provided, wherein the system comprises:
an endpoint arranged to determine link qualities between the endpoint and an access point with and without interference by a neighbor access point;
the access point arranged to receive the determined link qualities from the endpoint and to decide whether a time slot in a pre-reserved time channel used for communication between the access point and the endpoint is selected for exclusive use or for non-exclusive use based on a cross-over point defined based on the received determined link qualities; and
a network controller arranged to receive from the access point a decision as to whether the time slot in the pre-reserved time channel used for communication between the access point and the endpoint is selected for exclusive use or for non-exclusive use and to schedule the time slot in the pre-reserved time channel used for communication between the access point and the endpoint respecting the selected exclusive use or non-exclusive use.

According to a second aspect, an apparatus for controlling communication for interference handling in an optical wireless communication network is provided, wherein the apparatus is configured:
to determine link qualities between an access point and an associated endpoint with and without interference by a neighbor device; and
to share the determined link qualities with a scheduling function (which may be comprised in the apparatus or in a remote device) in order to determine whether a time slot in a pre-reserved time channel used for communication between the access point and the endpoint is selected for exclusive use or for non-exclusive use by the access point.

According to a third aspect, a method of controlling communication for interference handling in an optical wireless communication network is provided, wherein the method comprises:
determining link qualities between an access point and an associated endpoint with and without interference by a neighbor device; and
sharing the determined link qualities with a scheduling function in order to determine whether a time slot in a pre-reserved time channel used for communication between the access point and the endpoint is selected for exclusive use or for non-exclusive use by the access point.

Accordingly, the system performance can be improved by examining whether time slots in the time channels need to be scheduled for exclusive use or interference can be tolerated and thus parallel communication is allowed.

Pre-reserved time channel herein means a set of time slots within a scheduling cycle (e.g. one or more MAC cycle(s)) that are pre-reserved for communication by one or more APs to their respective EPs for transmissions that may cause interference. Pre-reserved time-channels are arranged such that when each AP limits the transmissions with its registered EPs to its pre-reserved time channel, that interference with neighboring cells is prevented, especially for the situation that EPs registered to an AP occur in the coverage area of neighboring APs. The subsequent determination further evaluates whether interference during the pre-reserved time-channel is harmful or that the interference cause can be tolerated, thereby adding further freedom to the scheduling. Time slots for transmission(s) between the one or more AP and an associated EP when allocated to the same time-channel may be scheduled in this pre-reserved time channel, possibly simultaneously.

It is further noted that in addition to transmissions scheduled in the pre-reserved time channel, an AP may also schedule transmissions outside the pre-reserved time channel, provided that these transmissions do not cause harmful interference with neighboring cells. An example of such transmissions are transmissions to EPs in its coverage area that are outside the exclusive regions.

According to a first option of the first, second or third aspect, the link qualities may be determined by using received signal qualities at low interference and at high interference. Low interference here refers to the situation wherein neighboring access points (or end points as the case may be) are not generating interfering signals, as a result a high link quality is to be expected. High interference in this context refers to the situation wherein one access point (or end point as the case may be) is generating interfering signals, as a result a lower link quality is to be expected. Combined the measurements provide insight in the available margin for interference on the link in the presence of traffic from the interfering access point (or end point).

According to a second option of the first, second or third aspect, which may be combined with the first option, the link qualities may be determined by comparing a bit rate of a time slot with high interference with a bit rate of a time slot with low interference. Thereby, the established bit rate on the link can be used as a readily available criterion for deciding about the exclusive use of a time slot. Similar to the first option, low interference here refers to the situation wherein neighboring access points (or end points as the case may be) are not generating interfering signals. Different from the first option, the second option may be used to compare the low interference situation with a situation where multiple neighboring access points (or end points as the case may be) are generating interfering signals. Preferably all neighboring access points (or end points) are used to generate interfering signals. By having all neighbors transmit a worst-case margin may be established and when sufficient no further measurements may be required. If insufficient margin is available, further measurements may be performed to single out the interference contributions from the individual interference sources in line with the first option.

According to a third option of the first, second or third aspect, which may be combined with the first or second option, the link qualities may be determined by using a low rate test signal to estimate an interfered bitrate and a non-interfered bitrate. This option shortens the reaction time, because there is no need to stabilize the link.

According to a fourth option of the first, second or third aspect, which may be combined with any one of the first to third options, at least one silent time slot may be used for estimating noise power. Thereby, a predetermined time slot can be provided during which no communication takes place so that noise power can be measured. The noise power measured in the silent slot can then be used together with a maximum bit rate measured, e.g. in another time slot (test time slot) with minimal interference, to determine an implementation gap (see fifth option below). Alternatively, it is also possible to define a single enhanced time slot with minimal interference which also includes at least one silence time period. Such an enhanced time slot can be used to estimate the maximum bitrate as well as the noise power to determine the implementation gap. Thus, the enhanced time slot with silence period(s) and minimal interference period(s) can be used for noise measurement and maximum bit rate measurement.

According to a fifth option of the first, second or third aspect, which may be combined with any one of the first to fourth options, the link quality may be measured in a test time slot where the interference is minimal and the bit rate is maximal. This measure ensures that a low-interference link is provided at predetermined times.

According to a sixth option of the first, second or third aspect, which may be combined with any one of the first to fifth options, selection of the time slot for exclusive use or for non-exclusive use may be determined based on a cross-over point which defines a threshold based on the shared determined link qualities. In an example, the threshold is preferably set such that it defines a threshold where an interference power has a first predetermined relation to a noise power and a second predetermined relation to a desired signal power. Thereby, a joint criterion for discriminating between exclusive and non-exclusive use of time slots can be applied.

According to a seventh option of the second aspect, which may be combined with any one of the first to sixth options, the apparatus of the second aspect may comprise the scheduling function for scheduling the time slot in the pre-reserved time channel used for communication between the access point and the endpoint respecting the selected exclusive use or non-exclusive use.

According to a fourth aspect, an endpoint for communicating with an access point which provides access to an optical wireless communication system is provided, wherein the endpoint comprises an apparatus according to the first aspect or any one of the first to fifth options.

According to a fifth aspect, an access point for providing access for associated endpoints to an optical wireless communication system is provided, wherein the access point comprising an apparatus according to the first aspect or any one of the first to seventh options.

According to a sixth aspect, an access point for providing access for associated endpoints to an optical wireless communication system is provided, wherein the access point comprises:
a receiver arranged to receive determined link qualities between the access point and an associated endpoint with and without interference by at least a neighbor device; and
a scheduler means arranged to:
   determine whether a time slot in a pre-reserved time channel used for communication between the access point and the endpoint is selected for exclusive use or for non-exclusive use based on a cross-over point defined based on the received determined link qualities and
   schedule the time slot in the pre-reserved time channel used for communication between the access point and the endpoint respecting the selected exclusive use or non-exclusive use.

According to a seventh aspect, a distributed or centralized network controller for providing a scheduling function for interference handling in an optical wireless communication system is provided, wherein the network controller comprises:
a receiver arranged to receive determined link qualities between the access point and an associated endpoint with and without interference by at least a neighbor device; and
a scheduler means arranged to:
   determine whether a time slot in a pre-reserved time channel used for communication between the access point and the endpoint is selected for exclusive use or for non-exclusive use based on a cross-over point defined based on the received determined link qualities and
   schedule the time slot in the pre-reserved time channel used for communication between the access point and the endpoint respecting the selected exclusive use or non-exclusive use.

According to an eighth aspect, a distributed or centralized network controller for providing a scheduling function for interference handling in an optical wireless communication system is provided, wherein the network controller comprises:
a receiver arranged to receive a decision as to whether a time slot in a pre-reserved time channel used for communication between the access point and the endpoint is selected for exclusive use or for non-exclusive use based on a cross-over point defined based on the received determined link qualities; and
a scheduler means arranged to schedule the time slot in the pre-reserved time channel used for communication between the access point and the endpoint respecting the selected exclusive use or non-exclusive use.

According to a first option of the seventh or eighth aspect, which can be combined with any one of the first to seventh options of the first, second or third aspect, the network controller may be configured to provide at least one of a silent time slot for noise measurement and a test time slot at which no detected neighbor access point is transmitting. This measure ensures that adequate measurement options are provided at a predetermined timing to reduce the reaction time of the scheduling system.

According to a second option of the seventh or eighth aspect, which can be combined with the first option of the seventh or eighth aspect or any one of the first to seventh options of the first, second or third aspect, the test time slot may be an advertisement slot on a common channel of a transmission frame (e.g. MAC cycle). Thereby, easy common access to the test time slot can be ensured.

According to a third option of the seventh or eighth aspect, which can be combined with the first or second option of the seventh or eighth aspect or any one of the first to seventh options of the first, second or third aspect, the network controller may be configured to select exclusive use if it determines that a maximum bit rate determined at an endpoint is larger than a joint throughput of an access point associated with the endpoint and a neighbor access point. Thus, the joint link situation at an associated access point and its neighbor access point can be considered when deciding about exclusive use of a time slot.

According to a fourth option of the seventh or eighth aspect, which can be combined with any of the first to third options of the seventh or eighth aspect or any one of the first to seventh options of the first, second or third aspect, the network controller may be configured to determine a test time slot for an access point at which interference from a neighbor access point occurs and to enforce the neighbor access point to schedule an interfering test signal in the test time slot. Thus, an interference measurement can be provided at a predetermined timing to optimize the scheduling behavior.

According to a ninth aspect, an optical wireless communication system is provided, that comprises at least one of a network controller according to the seventh or eighth aspect, an access point according to the fifth or sixth aspect and an endpoint according to the fourth aspect.

According to a tenth aspect, a computer program product is provided, which comprises code means for producing the steps of the above method of the second aspect when run on a computer device.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the system of claim 1, the endpoint of claim 2, the access point of claim 6 or 7, and the network controller of claim 8 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a block diagram of a LiFi network in which various embodiments can be implemented;

FIG. 2 shows schematically a block diagram of a LiFi network with neighbor reporting by an EP based on downstream advertisements;

FIG. 3 shows schematically a block diagram of a LiFi network with neighbor reporting by an AP based on upstream advertisements;

FIG. 4 shows schematically a MAC cycle with a common channel for neighbor reporting;

FIG. 5 shows schematically an exemplary scenario with three APs with overlapping coverage areas and seven EPs distributed over the coverage areas;

FIG. 6 shows a flow diagram of an interference handling control procedure according to various embodiments;

FIG. 7 shows schematically a block diagram of a network controller for enhanced scheduling according to various embodiments;

FIG. 8 shows schematically a MAC cycle with EP-restricted time slot scheduling of three APs;

FIG. 9 shows schematically a MAC cycle with EP-restricted time slot scheduling according to a first option with alignment of exclusive slots according to an embodiment;

FIG. 10 shows schematically a MAC cycle with EP-restricted time slot scheduling according to a second option with split time channels according to an embodiment;

FIG. 11 shows schematically a MAC cycle with EP-restricted time slot scheduling according to a third option with exclusive period per time channel according to an embodiment;

FIG. 12 shows schematically an example of an aligned maximum number of exclusive time slots at the start of a time channel according to an embodiment;

FIG. 13 shows schematically a MAC cycle with EP-restricted time slot scheduling according to the third option with two-part splitting of each time channel;

FIG. 14 shows schematically an illustration of a cross-over point on a logarithmic scale;

FIG. 15 shows an exemplary diagram with relative bit rates as a function of interference power on a logarithmic scale;

FIG. 16 shows schematically a MAC cycle with a test and silent time slot for estimating noise power;

FIG. 17 shows a flow diagram of a cross-over point determination procedure according to an embodiment;

FIG. 18 shows schematically a block diagram of a network device for enhanced scheduling according to various embodiments;

FIG. 19 shows schematically a processing and signaling diagram for a first cross-over point determination option based on signal power measurement;

FIG. 20 shows schematically a processing and signaling diagram for a second cross-over point determination option based on bit rate measurement;

FIG. 21 shows schematically a processing and signaling diagram for a third cross-over point determination option based on bit rate estimation; and

FIG. 22 shows schematically three examples of signal quality in relation to different signal constellations.

### DETAILED DESCRIPTION OF EMBODIMENTS

Various embodiments of the present invention are now described based on an optical multi-cell illumination and communication (LiFi) system.

Throughout the following, a luminaire as an AP is to be understood as any type of lighting unit or lighting fixture which comprises one or more light sources (including visible or non-visible (infrared (IR) or ultraviolet (UV)) light sources) for illumination and/or communication purposes and optionally other internal and/or external parts necessary for proper operation of the lighting, e.g., to distribute the light, to position and protect the light sources and ballast (where applicable), and to connect the luminaires to a power supply. Luminaires can be of the traditional type, such as a recessed or surface-mounted incandescent, fluorescent or other electric-discharge luminaires. Luminaires can also be of the non-traditional type, such as fiber optics based with the light source coupling in light in the fiber core or “light pipe” and coupling out the light at the other end.

Although access points for optical wireless communication may be integrated with luminaires, they can also be “standalone” OWC access point devices and may optionally be co-located with radio (RF) based, e.g. WiFi access points or be combined devices that can be used for both radio (e.g. WiFi) and LiFi thereby providing both high-speed line-of-sight access as well as convenient more omnidirectional wide-range access.

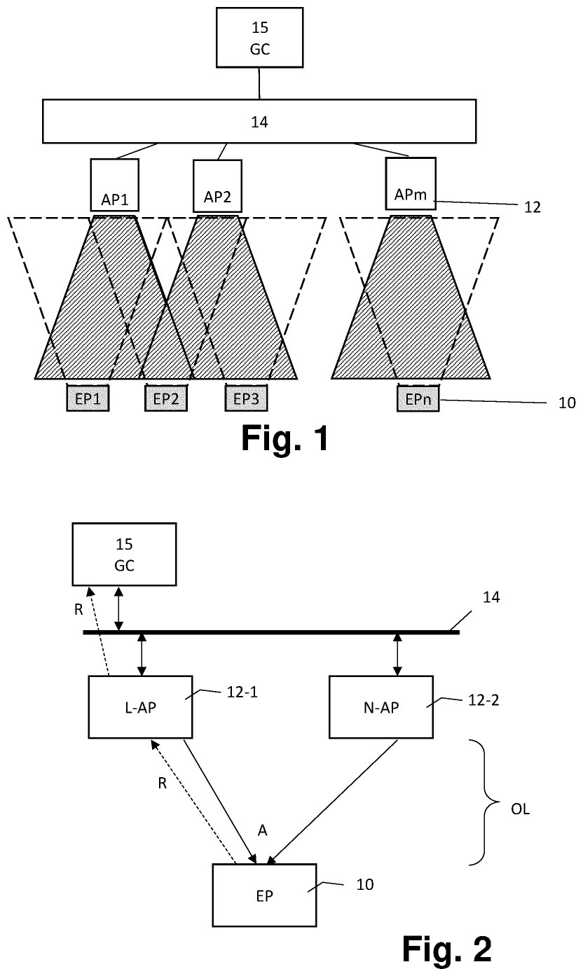

FIG. 1 shows schematically a block diagram of a LiFi network in which various embodiments can be implemented.

It is noted that—throughout the present disclosure—the structure and/or function of blocks with identical reference numbers that have been described before are not described again, unless an additional specific functionality is involved. Moreover, only those structural elements and functions are shown, which are useful to understand the embodiments. Other structural elements and functions are omitted for brevity reasons.

The LiFi network comprises multiple APs (AP1, AP2, . . . APm) 12, e.g. luminaires of a lighting system, connected to a backbone network (e.g. Ethernet or alike) 14 e.g. via a switch (e.g. an Ethernet switch, not shown), whereby each AP 12 controls one or multiple transceivers (not shown) (i.e. combined transmitters (optical emitters) and receivers (light sensors)) for optical communication towards EPs (EP1, EP2, . . . EPn) 10, e.g., mobile user devices. Each of the EPs 10 is registered to an AP 12. Respective downlink light beams generated by the transceivers of the APs 12 and defining coverage areas on the plane(s) of the EPs 10 are indicated by hashed trapezoids in FIG. 1. Furthermore, respective light beams generated by the transceivers and defining coverage areas on the plane(s) of the EPs 10 are indicated by the hatched trapezoids in FIG. 1. Similarly, respective light beams generated by transceivers of the EPs 10 and defining coverage areas on the plane(s) of the APs 12 are indicated by the dashed trapezoids in FIG. 1.

Where their coverage areas overlap, interference of the communication between APs 12 and EPs 10 can occur. Coordination of the APs 12 is therefore needed to handle the interference in overlapping areas.

A central global controller entity or function (GC) 15, provided e.g. in a LiFi controller, is connected to the backbone network 14 and configured to manage the LiFi network, which includes interference handling coordination. Interference handling can be implemented by providing time division multiple access (TDMA), wherein medium access control (MAC) cycles of the APs 12 are aligned and divided into slots.

Furthermore, the global controller entity 15 may be configured to control handover when one of the EPs 10 moves into and out of overlapping coverage areas of the APs 12. The global controller entity 15 may be connected via a switch of the backbone network 14 to the APs 12.

Additionally, the global controller entity 15 may be a centralized entity as shown in FIG. 1 but may also be co-located/integrated in a single AP 12, or its functionality may be partitioned and distributed over at least some of the APs 12. In a distributed implementation, elements of the functionality of the network controller are implemented in multiple communicating devices, however the combined functionality of those devices is that of the global controller. More specifically, a part of the functionality of the global controller entity 15 may be distributed and the remaining part of the functionality may be centralized. However, when a part of the functionality of the global controller entity 15 is distributed over APs 12, it may logically still have the same functionality as the global controller entity, which means that an EP 10 reports information to the global controller entity 15. Alternatively, (part of) the functionality of the global controller entity 14 as described herein may logically be part of an AP 12. Then, an EP 10 reports information to its local AP 12 which executes part of the required functionality and reports (an intermediate) result to the global controller entity 15.

FIG. 2 shows schematically a block diagram of a LiFi network with neighbor reporting by an EP based on downstream advertisements A broadcast via optical links (OL) by a local AP (L-AP) 12-1 to which an EP 10 is assigned and by a neighbor AP (N-AP) 12-2. Each of the APs 12-1, 12-2 advertises its presence, e.g. by sending out its identifier in an advertisement A in predefined slots. The EP 10 associated to the local AP 12-1 detects an advertisement A of the neighbor AP 12-2 and reports this to its local AP 12-1 in a reporting message R via an optical link. The local AP 12-1 informs the global controller 15 on neighbor AP detections in a corresponding reporting message R (e.g. via the backbone network 14). The global controller 15 coordinates the APs 12-1, 12-2 to handle the interference based on the received information.

Optionally, the global controller 15 may not differentiate interference handling for downstream communication (AP to EP) from upstream communication (EP to AP).

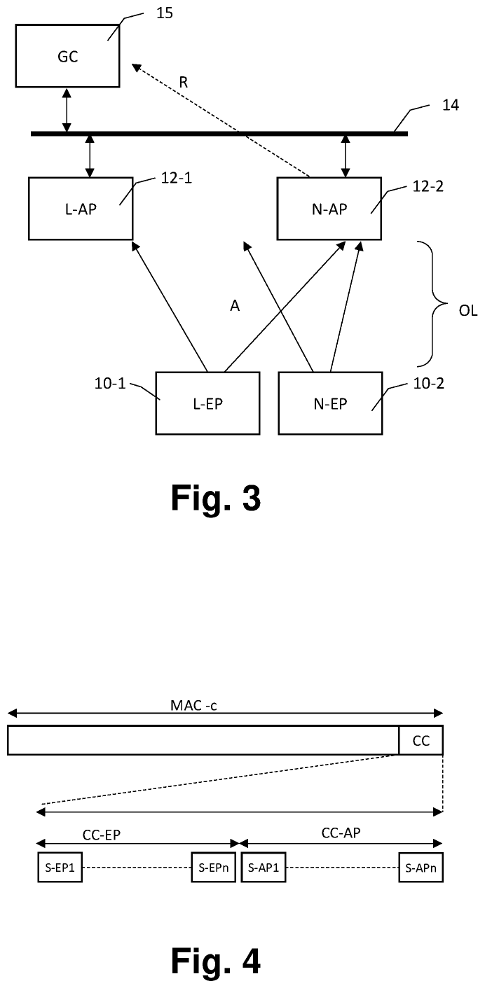

In various embodiments, it is assumed that an upstream coverage area equals or is at least similar to a downstream coverage area. If this is not the case, then upstream interference handling may be dealt with separately. In that case, an AP may instruct its associated EPs to advertise their presence as illustrated by FIG. 3, thereby obtaining further information on possible sources of interference.

FIG. 3 shows schematically a block diagram of a LiFi network with neighbor reporting by an AP based on upstream advertisements transmitted via optical links (OL). In this case, a neighbor AP 12-2 having an associated neighbor EP (N-EP) 10-2 receives advertisements A from a local EP (L-EP) 10-1 associated to a local AP (L-AP) 12-1 and informs the global controller 15 about this detection by sending a reporting message R (e.g. via the backbone network 14).

The presence advertisements A of APs and EPs may be frames that may be bundled into a dedicated part of a Media Access Control (MAC) cycle but may also be separate frames.

FIG. 4 shows schematically a MAC cycle (MAC-c) with a common channel (CC) period for neighbor reporting.

The common channel (CC) period comprises first dedicated advertisement slots S-EP1 to S-EPn, in which EPs may send advertisement frames, and second dedicated advertisement slots S-AP1 to S-APn, in which APs may send advertisements. The advertisements slots may be assigned such that the AP advertisements do not interfere, which can be achieved by assigning one or multiple exclusive slots to each AP for that purpose.

Further time channels may be pre-reserved e.g. depending on the overlapping coverage areas of the APs or depending on the actual reporting of EPs and APs detecting neighbor activity.

Interference handling can be achieved by pre-reserving time channels and applying restriction rules to determine which time slots each AP is allowed to use for which EPs to solve interference. This approach allows for a relatively simple implementation in the global controller 15. Then, given the result for each AP, each AP determines the final scheduling locally and may thereby adapt this to the actual local traffic load for each of its associated EPs.

However, this approach does not lead to optimal performance when too many time slots are reserved for exclusive use, which could have been utilized for non-exclusively use otherwise.

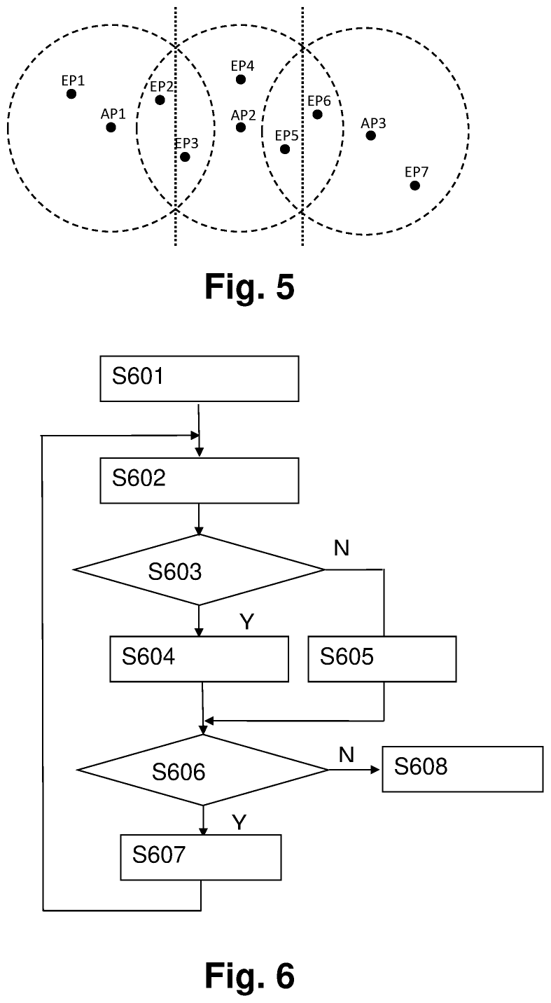

In an example (e.g. as shown in FIG. 5), a first EP (EP1) and a second EP (EP2) are registered/associated to a first AP (AP1), and a third EP (EP3) and a fourth EP (EP4) are registered/associated to a neighboring second AP (AP2). A predetermined area of the neighboring APs is defined as an area of exclusive use (“exclusive region”).

Conceptually, the exclusive region can be envisaged as a subset of the overlapping region of two access points where harmful interference may occur, more in particular, the exclusive region represents that part of the overlapping region where it is no longer advantageous to tolerate interference from the neighboring access points. The exclusive region need not be and is not mapped out in full. For the downlink, it suffices to establish whether individual EPs associated with an AP in an overlapping region with a neighbor AP, are in the exclusive region, for example based on the determined interference metrics for the respective AP-EP pairs. This situation applies analogously for the uplink.

An EP located in that exclusive region suffers from unacceptable interference when both APs transmit at the same time. The APs therefore apply exclusive slots for their registered EPs located in that exclusive region. Suppose the global controller has assigned time channels to the APs and that each time channel is completely reserved for exclusive use, then the following restriction can be applied:

For each EP, which is registered to APx, and located in the exclusive region of APx and APy:
1. APx must restrict the scheduling to this EP to its reserved time channel; and
2. APy must restrict the scheduling to its registered EPs by excluding them from the reserved time channel of APx.

It is noted is that these restriction rules are applied for each EP in an exclusive region which may be determined as described later.

If in the above example EP2 and EP3 are both located in an exclusive region, these restrictions may lead to a situation where AP1 is only allowed to schedule communication with EP1 and EP2 in TC1 and AP with EP3 and EP4 in TC2, as indicated by the following table:

| | TC1 | TC2 |
|---|---|---|
| AP1 | EP1, EP2 | [symbol] |
| AP2 | [symbol] | EP3, EP4 |

Thus, communication with EP1 and EP4 never occurs in parallel although they are both not located in an exclusive region. They could have been scheduled in parallel in those slots that are not used for EP2 and EP3.

The situation can be improved by determining which of the slots in pre-reserved time channels are actually chosen for exclusive use (i.e. for EPs in an exclusive region (EP2 and EP3)) and which slots are chosen for non-exclusive use (i.e. for EPs outside an exclusive region (EP1 and EP4)). Then for the latter, the APs could use the slots in parallel, meaning that in the above example, AP1 could use these slots for EP1 and AP2 could use these slots for EP4 without causing unacceptable interference.

Then, each AP notifies each of its neighbor APs if it will be using the next slot for exclusive use in relation to the neighbor AP. Based on these notifications, a neighbor AP checks if the next slot will not be exclusively used by any neighbor AP and if so, may schedule this slot for an EP outside any exclusive region.

Alternatively, each AP notifies the global controller for which of its neighbor APs if it will be using the next slot for exclusive use. The global controller then informs each neighbor AP if it is allowed to use the next slot for its EPs outside any exclusive region.

However, using this approach, an AP must notify the planned use of the next slot for exclusive use, which leads to increased communication overhead. Moreover, a neighbor AP has little time to adapt its scheduling.

Alternatively, each AP may determine the scheduling of all its slots in one or multiple MAC cycle(s) in advance. This allows to bundle the planned exclusive use in a single notification per MAC cycle (or multiple MAC cycles) and gives a neighbor AP more time to adapt its scheduling. However, flexibility for the local AP for last moment adaptation of its transmission schedule is reduced and hence latency may increase.

If an AP schedules its communication by polling its associated EPs, it first addresses the EP and communicates data downstream (D) in each poll action and then provides the EP the opportunity to communicate data upstream (U). A poll action can span multiple slots. The AP may determine the maximum length (maximum number of slots) before each poll action depending on (i) the actual amount of data waiting to be transmitted, and on (ii) the amount of consecutive slots for this EP according the allowed slots for this EP in the MAC cycle. However, the poll action may be shortened when no data is any more waiting to be transmitted. In this way, the AP can optimize the available time by preventing empty slots (scheduled slots in which no data is transferred). As a result, the scheduling of slots dynamically changes depending on the availability of data during the MAC cycle.

However, exclusive slots have to be scheduled individually per AP.

An AP may be surrounded by multiple APs with each of these APs having associated EPs in an exclusive region with the AP. Then, if each of these neighbor APs may schedule different slots of these EPs for exclusive use, the AP is not allowed to apply any of these slots.

FIG. 5 shows schematically an exemplary scenario with three APs (AP1 to AP3) with overlapping coverage areas and seven EPs (EP1 to EP7) distributed over the coverage areas.

In this example, AP1 and AP3 have been pre-reserved the same time channel (TC1) and AP2 a different time channel (TC2). AP1 schedules exclusive time slots for EP2 in TC1 and AP3 also schedules exclusive time slots for EP6 in TC1. AP2 is not allowed to schedule communication in these time slots. This could be resolved if EP2 would be scheduled simultaneously with EP6, which would leave more non-exclusive slots to AP2 to schedule communication and thus improving the performance.

According to various embodiments, it is assumed that the global controller applies scheduling by pre-reserving for each AP a time channel and determining which of the EPs associated to each AP need exclusive communication.

Proposed is a three-stage approach that starts with setting pre-reserved time-channels, a subsequent determination of exclusivity of time-slots in the pre-reserved time-channels (to prevent harmful interference), followed by the actual time-slot scheduling respecting the determined exclusivity. This approach facilitates distributed scheduling as the determination of exclusivity may be performed separate from the actual time-slot scheduling.

The pre-reserved time-channels may be generated in multiple ways, upon installation and subsequent commissioning/configuration the network layout can be reviewed, and a number of pre-reserved time-channels may be established. The above may work particularly well in static OWC networks as it limits overhead.

Alternatively, the pre-reserved time-channels may be based on historical reporting of AP neighbor relationship by EPs. In dynamic OWC networks, the focus may be on the more recent, up-to-date, AP neighbor relationship reporting, whereas in more static networks, a larger time-window may be preferable.

More alternatively the pre-reserved time-channels may be based on the determined link quality measurements, as also used for the in/out exclusive region determination. In practice time-slots in pre-reserved time-channels based on the determined link quality measurements do not need to be actually used; e.g. when there is little traffic that requires exclusivity. During the subsequent determination, unused (but pre-reserved) time-slots may be made available for non-exclusive use.

The number of time-channels in turn also affects performance. Firstly, using more time-channels will generally imply that the time-channels will be shorter. Reversely, when fewer time-channels are used this will generally result in longer time-channels. Secondly, the fraction of the time-channel that is reserved for exclusive use by an AP may affect performance, more in particular when a time-channel is reserved for exclusive use by an AP in its entirety, so not a subset of it, this may result in a loss in performance. Both features interact.

Consider a scenario using larger time-channels where the whole time-channel is reserved for exclusive use by one or more APs. In such a scenario neighboring APs have less transmission opportunities for their non-exclusive EPs. It is therefore beneficial not to reserve the entire time-channel for exclusive use by one or more APs. By reserving only part of a time-channel, performance can be increased, because then only the exclusive EPs get exclusivity in the reserved period of the time-channel, whereas non-exclusive EPs can be served in parallel in the remaining part of the time-channel.

In case only part of a time-channel is reserved for exclusive use, then the larger the time-channels (and thus the fewer the time-channels) the more flexibility in scheduling the EPs will be obtained. This is because the larger the time-channels, the more options exist for serving the exclusive EPs.

Summarizing, preferably, the number of time-channels is kept small, whereas their size is kept large, and time-channels are not fully reserved.

Further the total duration of the pre-reserved time channels may be equal to the MAC cycle, as this allows maximum flexibility for scheduling, but alternatively the total duration may also be chosen shorter than the total MAC cycle length.

The minimum number of time-channels depends on the number of conflicting transmitters and depends on the distribution of the EPs in the system. Conflicts may result directly from an EP associated with an AP also being in an exclusive region of other neighboring APs, each with their own associated EP(s). A lower-bound N may be formulated, based on direct conflicts, when an EP is maximally in the exclusive region of N neighboring APs, which all have associated EPs and thus want a time-channel of their own.

In addition to the direct conflicts also indirect conflicts may require further time-channels as a result of chaining effects. Indirect conflicts may occur when other APs in the system introduce conflicts that in turn require separate time-channels. Therefore, the number of time-channels can be established by considering the system in its entirety.

FIG. 6 shows a flow diagram of an interference handling control procedure according to various embodiments, which may be implemented in the global controller.

It is assumed that an EP is associated to a (single) AP having the highest signal strength for that EP.

In step S601 a target AP is set and in step S602 EPs associated with the target AP are determined (e.g. based on corresponding advertisements received from the APs). Then, it is checked in step S603 for each determined associated EP whether it is an exclusive EP (e.g. an EP located in an exclusive region) or not. This checking may be based on information received from EPs, APs or on own information derived from cross-over point considerations, as described later in detail.

Based on the result of the checking in step S603, either interference-tolerant communication scheduling is applied in step S605 for non-exclusive EPs (branch “N”) or exclusive communication scheduling is applied in step S604 for exclusive EPs (branch “Y”).

Then, after all associated EPs have been checked and classified, the procedure continues with step S606 where it is checked whether there are still APs that need to be considered for the scheduling classification process. If so (branch “Y”), a new target AP is set in step S607 and procedure jumps back to step S602 where all associated EPs are determined.

If all APs have been considered (branch “N” in step S606), the procedure branches to step S608 where the obtained classification of EPs at their associated APs is used for interference handling. E.g., based on the derived information, required time channels are determined and a single time channel is assigned to each AP, in which the AP is guaranteed to transmit (time channel pre-reservation).

Thus, the global controller (or alternatively each AP) determines for each AP which of its EPs are located in an exclusive region with respect to a neighboring AP and thus require exclusive use (exclusive EPs) and which of its EPs are not located in any exclusive region and thus do not require exclusive use (non-exclusive EPs).

An exclusive region is defined where the system applies exclusive communication for an EP in relation to a neighbor AP (meaning that when the local AP communicates with the EP, the neighbor AP shall not communicate), as compared to interference tolerance communication (meaning that when the local AP communicates with the EP, the neighbor AP may also communicate). A neighbor AP may however communicate if there is not any EP associated to the local AP which is located in the exclusive region of the local AP with respect to the neighbor AP. Then, the neighbor AP does not harm the EPs associated to the local AP and thus the neighbor AP can communicate in parallel with the local AP. The condition whether the system applies exclusive communication may be defined based on cross-over point considerations, as explained later.

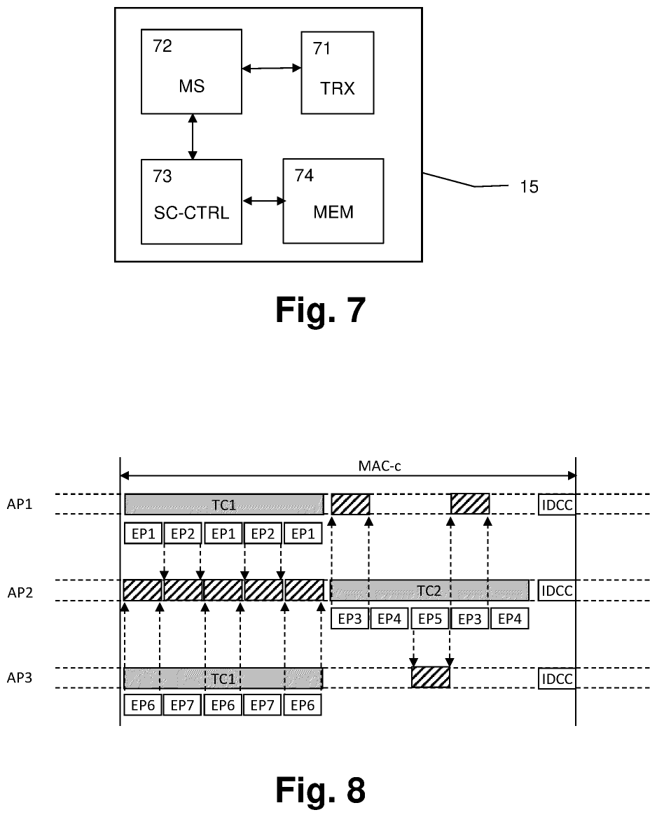

FIG. 7 shows schematically a block diagram of a global controller (e.g. global controller 15 of FIGS. 1 to 3) for enhanced scheduling according to various embodiments. It is noted again that only those blocks and/or functions are shown in FIG. 7, which are helpful to understand the present invention. Other blocks and/or functions have been omitted for brevity reasons.

The global controller comprises an interface (IF) 71 for communication via a backbone network (e.g. backbone network 14 of FIGS. 1 to 3) with APs or towards EPs (e.g., mobile user devices) via their associated APs.

Furthermore, the global controller comprises a mode selector functionality (MS) 72 for the selection of an interference-tolerant communication scheduling mode or an interference-restrictive and thus exclusive communication scheduling mode. The mode selector functionality 72 thereby relies on the information it receives via its interface 71, whereby this information can be a request or indication for a mode, or can be measurement results on which the mode selector can make a decision for a mode. The mode selector functionality 72 supplies control information that indicates the selected scheduling mode to a scheduling controller (SC-CTRL) 73, e.g., a software-controlled processing unit, to activate and provide respective enhanced scheduling functions for interference handling. The operation of the scheduling controller 73 makes use of a memory 74 in which program routines and parameters (e.g. neighbor information, exclusive region(s), and/or other look up tables) for scheduling interference handling are stored.

In an example, the mode selector functionality 72 may be integrated in the scheduling controller 73 e.g. as an additional software routine.

Thus, the scheduling controller 73 applies scheduling functions for interference handling (e.g. time slot allocation) based on control information received from the mode selector functionality 72.

The global controller may determine for each AP which of its EPs are located in an exclusive region. If an EP detects the advertisement of another AP, such AP may then be defined as neighbor AP. The global controller may determine an AP to be neighbor of another AP based on the actual situation (e.g. an EP is actually in the coverage area of a neighbor AP) but may also do so based on historical information (e.g. an EP was some time ago in the coverage area of a neighbor AP). The global controller may then arrange different time channels (time slots) for EPs in an exclusive region (exclusive communication scheduling mode).

For time channel allocation, both neighbor detection as well as the additional criterion of the exclusive region can be applied. This will have an influence on the number of time-channels. However, within a time channel, the time slots reserved for exclusive use are based on the exclusive region criterion.

FIG. 8 shows schematically a MAC cycle with EP-restricted time slot scheduling of three APs based on the exemplary scenario shown in FIG. 5 where EPS and EP6 are assumed to be in an exclusive region due to the overlapping area between AP2 and AP3 and where EP2 and EP3 are assumed to be in an exclusive region due to the overlapping area between AP1 and AP2.

To coordinate APs, the global controller may send a message to an AP indicating scheduling constraints as a result of the selected scheduling modes for different EPs. These constraints indicate in which slots it allows an AP to schedule which type of frames to which EPs. With these constraints, the global controller can arrange time division multiple access between APs where needed. E.g., as already described above, for an EPn that is associated to an APx and appears to be in the coverage area of an APy, the network controller may apply the following time division restrictions:
(1) scheduling of data by APx with EPn is restricted to a (set of) time slots X in the MAC-cycle; and
(2) scheduling of data by APy with its associated EPs is restricted by excluding the (set of) time slots X.

After the global controller has pre-reserved time channels to the APs, it may apply the above restriction rules (1) and (2) to determine which slots each AP is allowed to use for which EPs, to solve potential interference problems.

Then, given the result for each AP, each AP may determine a final scheduling locally and may thereby adapt the scheduling to the actual local traffic load for each of its associated EPs.

As can be gathered from FIG. 8, AP1 schedules exclusive time slots for EP2 in TC1 and AP3 also schedules exclusive time slots for EP6 in TC1. These exclusive time slots are indicated in FIG. 8 by parallel hatched areas in the time channel of the neighbor AP (AP2). As a result, AP2 is not allowed to schedule any communication in the first time channel TC1, while AP1 loses two time slots and AP3 loses one time slot in the second time channel TC2 due to exclusive time slots scheduled by AP2 for EP3 and EPS.

However, this approach does not lead to optimal performance when too many time slots are reserved for exclusive use, which could have been utilized for non-exclusive use otherwise.

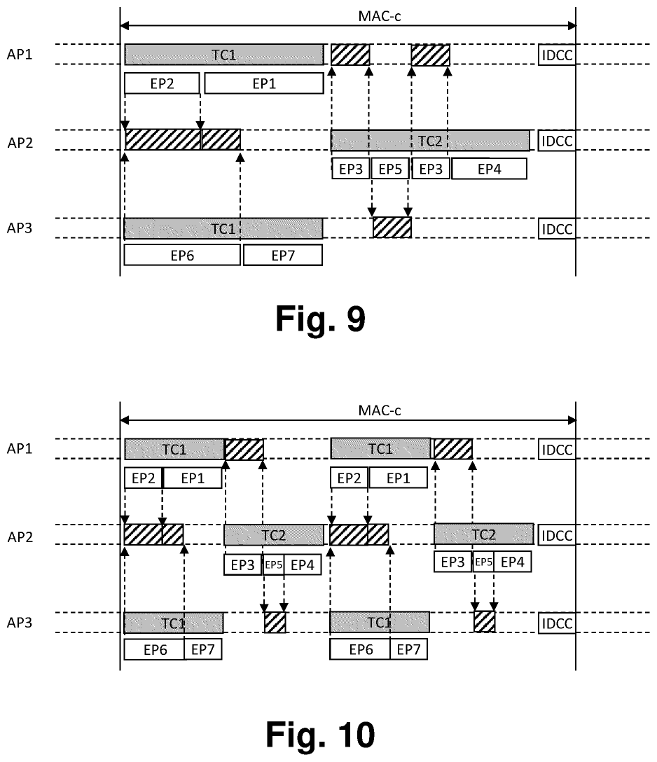

FIG. 9 shows schematically a MAC cycle with EP-restricted time slot scheduling according to a first option for enhanced scheduling by alignment of exclusive slots according to an embodiment.

An AP notifies each neighbor AP if the next slot is used exclusively in relation to that neighbor AP. The AP may communicate directly to its neighbor APs for that purpose or may communicate its notifications to the global controller which then forwards the communication to the neighbor APs.

Instead of choosing the slots for exclusive use freely within the pre-reserved time channel, an AP now chooses them in alignment with other APs. Such alignment could be arranged by the global controller or by applying a common rule. This enables several sub-options. It leads to an increase of opportunities for an AP with multiple neighbor APs, whereby these neighbor APs have EPs associated that are in an exclusive region with the AP (as illustrated in FIG. 9 compared to FIG. 8).

In a first example, an AP selects the exclusive slots all to be consecutive within its pre-reserved time channel, whereby the start of these exclusive slots is aligned to the start of the pre-reserved time channel.

As a result, AP2 is now allowed to schedule to EP4 in TC1 while both AP1 is communicating to EP1 as well as AP3 is communicating to EP7.

Such alignment also allows to reduce the communication overhead. Instead of notifying the planned use for the next slot at every slot, the AP may only notify that the remaining slots in the time channel are for non-exclusive use at the last exclusive slot, so only once per MAC-cycle or once per multiple MAC-cycles.

In a second example of the first option, instead of aligning the exclusive slots to the start of the time channel, they can be aligned to the end of the time channel.

In a third example of the first option, to improve latency, the global controller may split each time channel into parts. Then, an AP schedules its exclusive slots equally over different parts of its pre-reserved time channel and selects the exclusive slots all to be consecutive within each part of its pre-reserved time channel, whereby the start of these exclusive slots is aligned to the start of each part of the pre-reserved time channel.

FIG. 10 shows schematically a MAC cycle with EP-restricted time slot scheduling according to the third example of the first option with split time channels. Here, the two time channels TC1 and TC2 are split into two equal parts. Thereby, the waiting time for the next available time slot can be reduced. Compared to the situation of FIG. 9, the maximum time between communication opportunities can be reduced by about 50% (e.g., for scheduling EP2). In the example of FIG. 10, AP2 can start exclusive communication for EP3 and EPS and non-exclusive communication for EP4 after expiry of the first part of the first channel TC1 already.

According to a second option for enhanced scheduling, instead of predetermining a schedule, in which the slots for each EP are determined for one or multiple MAC cycles, the AP may determine the (maximum) number of slots in a MAC cycle that it needs or to which it is limited for exclusive use. It can do so for e.g. a single MAC cycle, but also for a sequence of multiple MAC cycles. The AP may thereto consider the traffic demand and/or load for exclusive use (i.e. for EPs associated to the AP in an exclusive region) and the traffic demand and/or load for non-exclusive use (i.e. for EPs associated to the AP in a non-exclusive region). Alternatively, the global controller may determine that for each AP, thereby taking information from neighbor APs of each AP into account in order to aim at a more global optimization. To achieve this, each AP may provide the global controller with the traffic load for exclusive use and the traffic load for non-exclusive use. This allows an AP to adapt the scheduling of the exclusive slots given that it does not exceed its set maximum number.

A possibility to control the number of exclusive slots is to assess whether the AP or global controller considers this number to be too small for a MAC cycle and then to increase it for a next MAC cycle and vice versa, e.g., in an iterative control-loop manner.

The actual traffic demand and/or load for an EP can be determined by the AP according to the amount of data waiting to be transferred for that EP. The traffic is bi-directional, so from AP to EP and from EP to AP. The traffic demand can be separately handled for the two directions. If the direction is not differentiated, then the bi-directional traffic load may be considered e.g. as the sum of the traffic load in both directions.

In the present disclosure, the total traffic load of an AP shall be understood as the amount of data waiting to be transferred for all its associated EPs, the total exclusive traffic load of an AP shall be understood as the amount of data waiting to be transferred for its associated EPs in an exclusive region, and the total non-exclusive traffic load of an AP shall be understood as the amount of data waiting to be transferred for its associated EPs not in any exclusive region.

In the following, examples for determining the number of exclusive slots per AP in a MAC cycle according to the second option are explained. The examples depend on whether minimal throughput of exclusive users or overall system throughput or fairness among the user's data rate shall be optimized.

According to a first example of the second option, determination is done by the AP, considering information only from the AP itself. For each AP, the ratio of its total exclusive traffic load to its total traffic load is calculated, wherein the exclusive traffic load may be weighted according to a weighting factor β and the non-exclusive traffic load may be weighted by (1−β). If β>0.5, then more priority is given to exclusive EPs compared to non-exclusive EPs and vice versa.

According to a second example of the second option, determination is done by the global controller considering also information from neighbor APs. For each AP, the ratio of its total exclusive traffic load to the sum of its total non-exclusive traffic load and the total non-exclusive traffic load of all neighbor APs is calculated. Once it is determined which EPs are in an exclusive region and which EPs are in a non-exclusive region, every AP may report the total excusive traffic load and non-exclusive traffic load to the global controller. The global controller may then calculate the ratios, which may be multiplied by the number of time slots in the time channel. In an example, the number of exclusive slots for every AP may be obtained by rounding or ceiling of the resulting numbers.

According to a third example of the second option, determination is done by the global controller considering also information from neighbor APs. For each AP, the ratio of its total exclusive traffic load to the maximum of its total non-exclusive traffic load and the total non-exclusive traffic load of every neighbor AP is calculated.

According to a fourth example of the second option, determination is done by the global controller considering also information from neighbor APs. For each AP, the ratio of its total exclusive traffic load to the average of its total non-exclusive traffic load and the total non-exclusive traffic load of every neighbor AP is calculated.

According to a fifth example of the second option, determination is done by the global controller based on a control loop concerning the actual fit of the number of exclusive slots. For each AP, it is evaluated whether the number of exclusive slots was fitting well, e.g. at the end of the time channel (or time channel part). If it had too little exclusive slots, then it increases the amount, if it had too many slots, it decreases the amount.

In a third option for enhanced scheduling by providing an exclusive period per time channel, the above first and second options are combined. Each AP (or the global controller) determines the maximum number of exclusive slots for a MAC cycle as in the second option and aligns them as in the first option. Different from the first and second options is that the AP does not need to notify if it is using the next slot exclusively. The AP also does not need to schedule each exclusive slot to an EP in advance. Instead, the AP or the global controller determines a set of slots in the MAC cycle for exclusive use to EPs in one or multiple MAC cycles and indicates to the neighbor APs which slots are used exclusively. This allows to reduce communication overhead while still providing freedom to dynamically adapt the use of exclusive slots (adapt the set of exclusive slots and adapt the scheduling of exclusive EPs within that set of slots) according to the actual need.

In the first and second option, the AP notifies per slot if it will schedule the next slot for exclusive use. This allows to adapt the scheduling of the next slot dynamically, but to the disadvantage of additional communication overhead and/or very short time for the neighbor AP to take advantage of the opportunity of an un-used exclusive slot. In the first option, the AP does not need to notify per every slot, it only needs to notify its neighbor APs or the global controller when the AP is done with exclusive use, so once per MAC cycle. However, the AP does not know beforehand when this will happen and thus the neighbor APs can receive this message at any time. To avoid these disadvantages, but still allow to adapt the scheduling of exclusive slots to the actual need, the AP determines an exclusive period for (each part of) its time channel. Alternatively, the global controller determines that for an AP.

In an example, each AP determines the need for the number of exclusive slots at every MAC cycle or at every N MAC cycle and notifies that to the global controller. Alternatively, each AP indicates the needed parameters on which the global controller determines the number of exclusive slots per AP as explained in the second option. The global controller then determines for each AP, the reserved period(s) for the next MAC cycle(s).

In a distributed scheduling system, APs may share information about exclusive/non-exclusive time slots by having local APs notify the size of their exclusive region to their neighboring APs and their neighboring APs may adapt their schedule accordingly. In a centralized scheduling system, the global controller may determine the size of the exclusive region of every AP and may notify this to the APs.

Furthermore, in a distributed scheduling system where the global controller is distributed over different APs, a local part of the global controller may determine the size of the exclusive region and may notify that to the other parts of the global controller.

The exclusive slots in the exclusive region applied by an AP may only need to be notified to the neighboring APs to which this exclusivity applies. If an AP has no EP in an exclusive region in relation to a neighbor AP, this neighbor AP does not need to be notified. This is the case e.g. when no EP is located in the coverage area of (potential) neighbor AP, but also when EPs are in the coverage area of a neighbor AP, but interference is tolerated (as they are not located in the exclusive region).

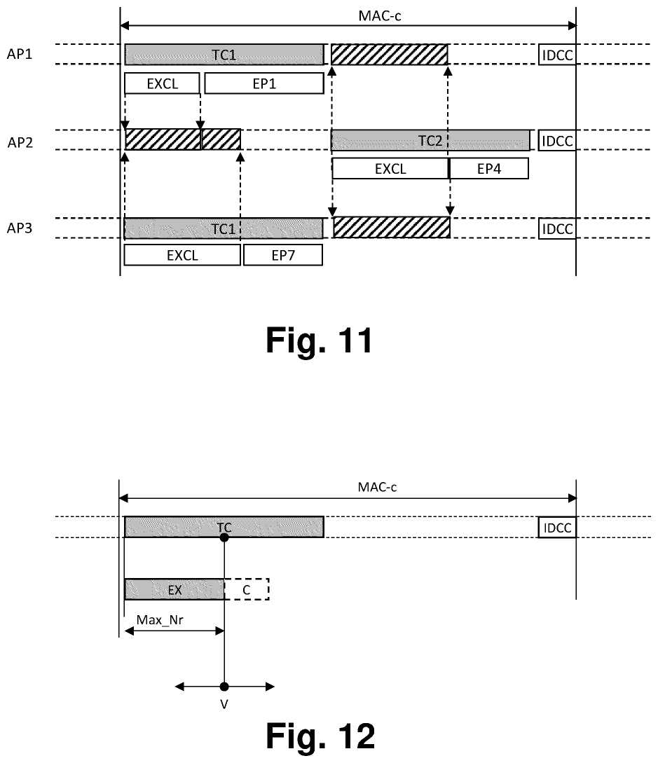

FIG. 11 shows schematically a MAC cycle with EP-restricted time slot scheduling and an exclusive period (EXCL) per time channel according to the third option.

Compared to the scheduling in FIG. 8, the reduced length of the exclusive period of AP1 and AP3 increase the opportunities for AP2 in TC1, but AP2 decreases the opportunities for AP1 and AP3 in TC2. The cause of the latter is that AP2 does not differentiate the exclusivity of its slots for AP1 and AP3.

Compared to the scheduling in FIG. 9, AP2 decreases the opportunities for AP1 and AP3 in TC2, because AP2 does not differentiate the exclusivity of its slots for AP1 and AP3.

The third option can be regarded as a good trade-off to maintain flexibility of adapting the scheduling of exclusive slots, thereby keeping the communication overhead and reaction time of the neighbor AP limited and achieving an adequate performance.

FIG. 12 shows schematically an example of an aligned maximum number of exclusive time slots (EX) at the start of a time channel according to an example of the third option.

An arbitrary AP aligns its exclusive slots (EX) to the start of its pre-reserved time channel and the (maximum) number (Max_Nr) of slots in a MAC cycle for exclusive use. The latter may vary depending on the traffic load for exclusive use and for non-exclusive use, as explained above in connection with the second option.

The global controller may determine a set of (aligned) slots to be used for EPs that are candidate for exclusivity. Each AP may thereto provide the necessary parameter to the global controller, which could be e.g. the traffic load for candidate exclusive use, or the traffic load for EPs in the coverage area of a neighbor AP (which includes the exclusive EPs).

In an example, the AP may also align slots (C) for communication with EPs that are candidate (Cand) for exclusivity. As explained above, such a candidate EP is an EP that is in the coverage area of a neighbor AP but not (yet) in the exclusive region of the neighbor AP.

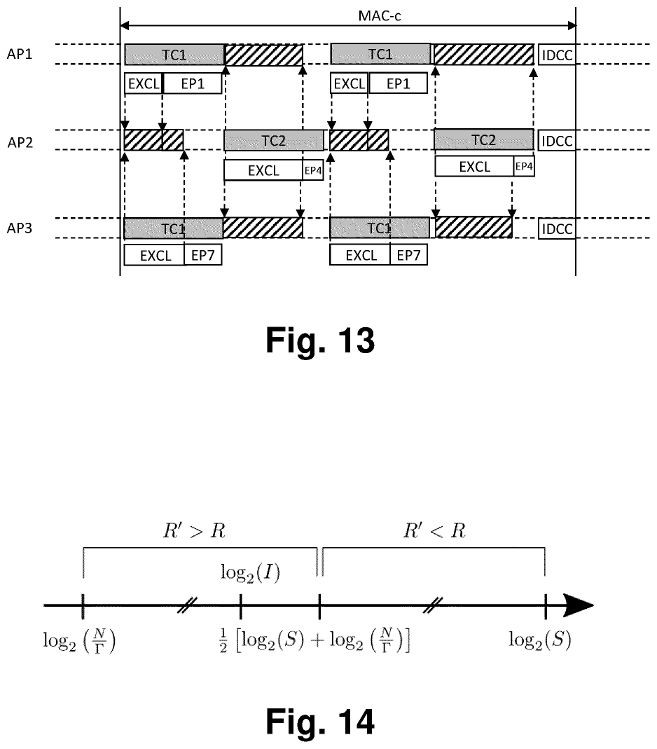

FIG. 13 shows schematically a MAC cycle with EP-restricted time slot scheduling according to the third option with two-part splitting of each time channel. Similar to FIG. 10, the time channel TC1 and TC2 are split into two equal parts here, so that the waiting time for the next available time slot can be reduced. E.g., AP2 needs to wait less time until it can use the second time channel TC2 for non-exclusive communication of EP4.

To avoid unfair behavior among APs, each AP may apply the same criteria for determining its communication needs. Therefore, the criteria to decide on the number of exclusive slots may be determined by the global controller for the APs. Therefore, each AP may provide necessary parameters to the global controller, which can be e.g. the traffic load for exclusive use and the total traffic load. Of course, other parameters are possible, based on which the global controller can derive the above parameters or the number of exclusive slots per AP.

According to various embodiments, the determination as to whether an EP is located in an exclusive region is made under consideration that interference may be tolerated if the EP detects to be in the coverage area of a neighboring AP. Thereby, performance can be increased by tolerating interference to a certain extent.

Therefore, a cross-over point for an AP communicating to an EP from (1) tolerating interference from a neighbor AP (denoted as AP′) to (2) applying time division is defined, where the bit rate for applying time division starts to exceed the bit rate for tolerating interference.

In an example, a simple rule for the cross-over point is to assume that a fraction a of the time is available for time division scheduling, meaning that the cross-over point is reached when

R=αRₘₐₓ=R′,

with
α fraction of available time when applying time-division;
R bit rate when applying time-division;
R′ bit rate when tolerating interference; and
Rₘₐₓ bit rate without interference.

As an example, α=0.5 which equally divides the time between the AP and its neighbor AP.

Depending on quality-of-service demands, APs might be willing to bias towards exclusivity, as then probability of retransmissions and thus latency can be minimized.

In another example, preference may first be given to simultaneous transmission, as then most APs can use the channel simultaneously and react when something goes wrong, instead of solving the interference before it took place. This approach corresponds to the second and third cross-over point determination options described later.

Alternatively, the scheduling system may determine periodically on-the-fly, if simultaneous transmissions in a particular location fail too often resulting in retransmissions, and in view of that either recalibrate or bias that region for exclusivity.

Tolerating interference can be on a packet by packet basis, depending on queue sizes in the APs, or can be performed on a session basis, thus proactively prohibiting any potentially conflicting transmission, even if the AP may occasionally not have any message to transmit. The former optimizes throughput, the latter limits the complexity of communication in the backbone network.

It is noted that the cross-over point can be applied both for AP-to-EP communication (downstream communication) and EP-to-AP communication (upstream communication).

The above parameters can be calculated as follows:

$${R}_{max} = B {log}_{2} ( \frac{S}{Γ N} + 1 ) \approx B {log}_{2} ( \frac{S}{Γ N} )$$

$$R = α B {log}_{2} ( \frac{S}{Γ N} + 1 ) \approx α B {log}_{2} ( \frac{S}{Γ N} )$$

$${R}^{′} = B {log}_{2} ( \frac{S}{Γ ( N + 1 )} + 1 ) \approx B {log}_{2} ( \frac{S}{Γ I} )$$

with
a fraction of available time when applying time-division;
S received signal power at EP from the AP to which the EP is associated (desired signal power);
I received signal power at EP from a neighbor AP′ (interfering signal power);
N received noise during a silent slot; and
Γ implementation gap.

The approximations in the above equations are justified for an interference limited system in which the interference power is larger than the noise power (I>>N), if any, and high signal-to-interference-noise-ratio (SINR) regimes (S>>Γ(N+I)).

In an example, a rudimentary assessment of a small number of cells of the LiFi network may be used. A pre-selection of APs for which interference is considered in the decision for applying time-division may be based on whether the APs are detected as neighbor AP. This reduces the number of APs for taking into account in the calculation of exclusivity. If the bitrate drops below a predefined threshold caused by interference from a number of APs, exclusive time division scheduling could be applied for all APs that are considered to be interfering, but may also be first for the AP with the highest received power followed by examining the other APs. FIG. 14 shows schematically an illustration of a cross-over point on a logarithmic scale for α=0.5. The cross-over point is at the location where the interfering rower is in the middle between the noise power and the desired signal power, at

$$\frac{1}{2} [ {log}_{2} ( S ) + {log}_{2} ( \frac{N}{Γ} ) ] .$$

That is, below the cross-over point, the bit rate (R′) when tolerating interference bit rate is greater than the bit rate (R) when applying time-division, while above the cross-over point, the bit rate (R′) when tolerating interference bit rate is smaller than the bit rate (R) when applying time-division.

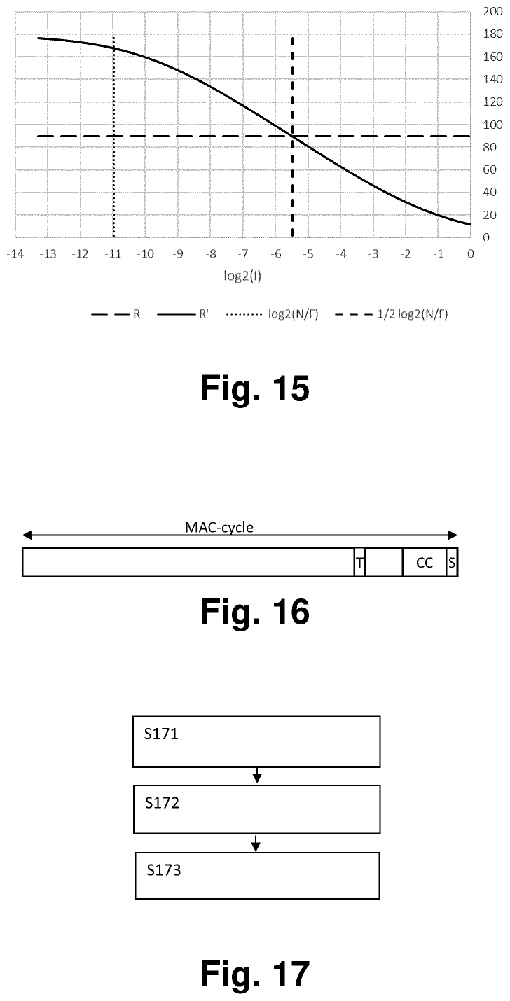

FIG. 15 shows an exemplary diagram with relative bit rates as a function of interference power on a logarithmic scale for α=0.5, S=1, Γ=2, N=0.001, B=20 MHz with the cross-over point accordingly at

$$\frac{1}{2} {log}_{2} ( \frac{N}{Γ} ) ,$$

as indicated by the right vertical dotted line in FIG. 15.

According to various embodiments, the link quality for an AP-EP combination may be measured when the interference is minimal and the bit rate is maximal (i.e. Rₘₐₓ). This can be used as a reference for other measurements, e.g. to relate the measured link quality when the interference is stronger and thus the bit rate is reduced (R′). For this purpose, the global controller may (temporarily) arrange a slot or some slot(s) in which it assures that none of the neighbor APs detected by the EP, is transmitting in that slot(s) (for the downlink stream assessment) or none of the neighbor EPs is transmitting in that slot(s) (for the uplink stream assessment).

Thus, the global controller determines a test time slot for an AP at which neighbor AP interference is minimal and coordinates the AP and its neighbor APs accordingly. The neighbor APs shall not schedule any communication in that slot.

In an example, the test time slot may be an advertisement slot in the common channel (CC) of the MAC cycle.

FIG. 16 shows schematically an example of a MAC cycle with a test time slot (T) and a silent time slot (S) for estimating noise power to enable the AP-EP combination to determine the maximum bit rate at this slot.

FIG. 17 shows a flow diagram of a cross-over point determination procedure according to an embodiment.

In step S171, the interference-free link quality (e.g. Rₘₐₓ) is measured for an AP-EP combination at minimal interference, e.g., by using a predetermined test time slot. Then, in step S172, the measured link quality is compared with other link quality measurements (e.g. R or R′). Finally, the result of the comparison is used to determine the cross-over point or at least whether the considered EP is located in an exclusive region and thus needs to be scheduled in an exclusive time slot.

The global controller may be configured to maintain a test time slot for several MAC cycles to enable the AP and EP to stabilize a test link. Alternatively, the AP may apply a low bit rate test signal according to the third option described below.

The test signal may be an advertisement frame arranged to be interference-free.

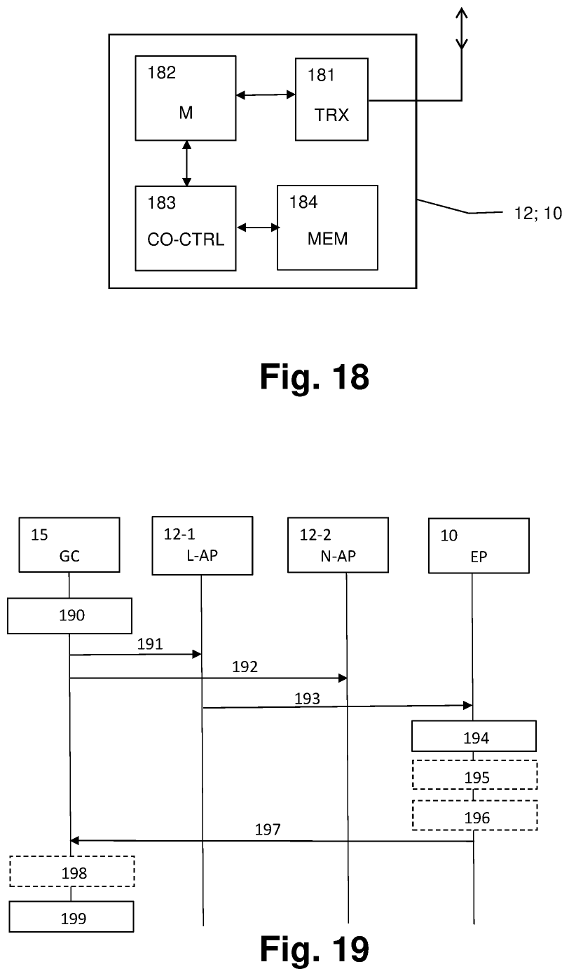

FIG. 18 shows schematically a block diagram of a network device (e.g. EP 10 or AP 12) for enhanced scheduling according to various embodiments.

It is noted again that only those blocks and/or functions are shown in FIG. 18, which are helpful to understand the present invention. Other blocks and/or functions have been omitted for brevity reasons.

The network device comprises a transceiver (TRX) 181 (i.e. a combined optical transmitter and receiver) for optical communication via an optical link of an AP-EP combination.

Furthermore, the network device comprises a measurement functionality (M) 182 which can be controlled to perform link quality measurements based on signals received via the transceiver 181. The measurement functionality 182 supplies measurement results to a cross-over controller (CO-CTRL) 183, e.g., a software-controlled processing unit, to enable determination of exclusive time slots for EPs based on cross-over point considerations for interference handling. The operation of the cross-over controller 183 makes use of a memory 184 in which program routines and parameters (e.g. measurement results, neighbor devices, exclusive region(s), and/or other look up tables) for scheduling interference handling are stored.

In an example, the measurement functionality 182 may be integrated in the cross-over controller 183 e.g. as an additional software routine.

Thus, the cross-over controller 183 applies AP/EP-related scheduling functions for interference handling (e.g. time slot allocation) based on measurement results received from the measurement functionality 182.

FIG. 19 shows schematically a processing and signaling diagram for a first cross-over point determination option based on signal power measurement.

In the signaling and processing sequence of FIG. 19, the vertical direction from the top to the bottom corresponds to the time axis, so that messages or processing steps shown above other messages or processing steps occur at an earlier time. Involved devices are a global controller (GC) 15, a local AP 12-1 of a considered EP-AP combination, a neighbor AP 12-2 of the considered EP-AP combination, and an EP 10 of the considered EP-AP combination.

According to the first cross-over point determination option, the received signal strength (signal power) of advertisements from an associated transmitter (i.e. local AP) and non-associated transmitter(s) (i.e. neighbor AP(s)) is used to assess the cross-over point.

For applying the above equations, an implementation gap must be estimated, which can be derived from the maximum bitrate and the noise. So, when the maximum bitrate is determined and the noise is estimated, it is possible to derive the implementation gap. The implementation gap can alternatively be a predetermined value, that is determined during system development and established empirically. In a practical system used by the inventors, the implementation gap was between 4 and 10 (6 to 10 dB). The implementation gap is only to a limited extent particular to the modulation and coding scheme and to the required bit error rate. From technical literature, such as S. Mardanikorani, X. Deng and J. M. G. Linnartz, “Sub-Carrier Loading Strategies for DCO-OFDM LED Communication,” in IEEE Transactions on Communications, vol. 68, no. 2, pp. 1101-1117, February 2020, it is known that a constant value of 6 or 7 dB, is realistic and sufficiently accurate for optimizations. Additionally, a small further margin of a few dB may be used to account for imperfections in the electronic circuits, hence the typical range of 6 to 10 dB.

It is assumed that the EP is enabled to determine the maximum achievable bit rate (Rₘₐₓ) at no interference. The global controller 15 determines in step 190 a silent time slot for noise estimation, e.g. at the very end of a MAC cycle, and instructs in steps 191 and 192 all APs to arrange this by forbidding any communication in that slot. Then, in step 193 each AP (e.g. local AP 12-1) indicates to its associated EP(s) (e.g. EP 10) where a silent slot exists in the MAC cycle.

Then, in step 194, the EP performs noise measurements with the silent slot.

In optional step 195, the EP 10 may determine the cross-over point e.g. based on the above equations. Thereafter, in optional step 196, the EP 10 may determine whether time division scheduling or interference tolerated scheduling is to be applied.

In subsequent step 197, the EP 10 indicates to the global controller whether it needs time-division or not for a neighbor AP. The global controller 15 may responds to the request, e.g., with an acknowledgement (not shown in FIG. 19).

In an alternative example, the global controller 15 may need measurement information to assess itself whether it must tolerate interference or apply time division with exclusive time slots for the EP 10. The EP 10 thereto directly reports the measurement result(s) to the global controller 15 in step 197 and skips optional steps 195 and 196. This reporting may be in addition to neighbor AP detection reporting, may be reported separately or joined, or may even replace the neighbor AP detection reporting. Then, the global controller 15 determines the cross-over point and scheduling mode in optional step 198.

Finally, in step 199, the global controller set the scheduling mode as determined before and coordinates the APs according to the information it receives from the EPs by applying time-division scheduling or not. The global controller can achieve this via the constraints it imposes on the scheduling of the APs.

Alternatively, the EP 10 may report the measurement results to the local AP 12-1 instead of to the global controller 15. Then, the local AP 12-1 forwards the reported measurement results to the global controller 15. The local AP 12-1 may also include steps 198, 199 and reports the scheduling mode to the global controller 15.

In addition to monitoring the advertisements of APs to detect when an EP is in the coverage area of a neighbor AP, the EP may measure in step 194 the received signal strength (S) of received advertisement of its associated AP, the received signal strength (I) of received advertisement of a neighbor AP, the noise (N) during the silent period, and the implementation gap (F) which can be derived from the maximum bit rate that occurs without interference from neighbor APs.

Based on these measurements, the EP 10 or the global controller 15 can determine a cross-over point for the EP in step 195 or 198, i.e., whether it is better to tolerate interference or to apply time-division for each interfering neighbor AP.

To determine the noise, the EP may alternatively be informed that the APs synchronously apply a small silent period, as described above.

As another option, the maximum bit rate may be defined assuming that at least for some slots the interference of neighbor APs is minimal and so the bit rate is maximal, as follows:

$${R}_{max} = B {log}_{2} ( \frac{S}{Γ N} + 1 ) \approx B {log}_{2} ( \frac{S}{Γ N} ) Γ = \frac{S}{N ( {2}^{\frac{{R}_{max}}{B}} - 1 )} \approx \frac{S}{N {2}^{\frac{{R}_{max}}{B}}}$$

This equation can thus be used to determine the implementation gap based on Rₘₐₓ.

The cross-over point can be derived from the above parameters as follows:

$${R}^{′} = R \frac{S}{Γ I} = {( \frac{S}{Γ N} )}^{α} {S}^{1 - α} {N}^{α} = I {Γ}^{1 - α} C = \frac{{S}^{1 - α}}{I} \frac{{N}^{α}}{{Γ}^{1 - α}} = 1$$

### For

$$α = 0.5 {S}^{0.5} {N}^{0.5} = I {Γ}^{0.5} S N = {I}^{2} Γ C = \frac{S}{{I}^{2}} \frac{N}{Γ} = 1$$

The system (e.g. global controller 15) may then be configured to decide to apply time-division scheduling when C<1.

As indicated above, the scheduling mode can be determined directly by the EP 10, which then reports to the global controller 15 or the local AP 12-1 that it needs time-division.

Alternatively, the EP 10 may reports its measurements to the global controller 15, which then determines for the EP whether its needs time-division.

In the first cross-over point determination option, the interference is regarded for a single neighbor AP. When multiple neighbor APs are causing interference, the cross-over point may be determined for each neighboring AP separately.

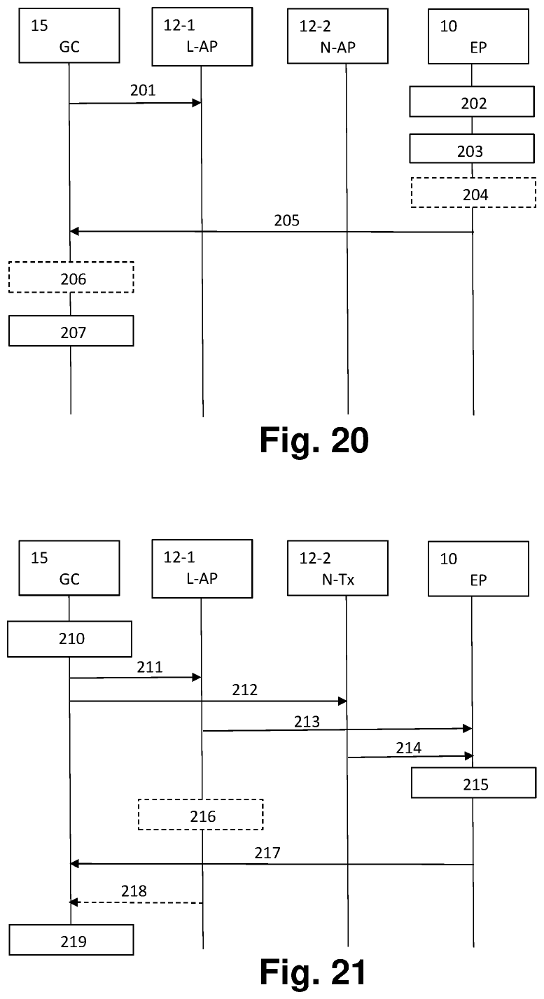

FIG. 20 shows schematically a processing and signaling diagram for a second cross-over point determination option based on bit rate measurement.

According to the second cross-over point determination option, a bit rate of slots with high interference is compared with that of low interference.

For a system with link adaptation (e.g. adaptive bit loading), it takes some time to stabilize the link and to establish a stable bit rate. Moreover, it suffers from varying interference especially when the interference for an EP differs per slot in a MAC cycle and differs for a slot over multiple MAC cycles. This increases the reaction time of the system to determine whether time-division scheduling is needed for an EP.

The second cross-over point determination option may thus suffer from uncertainty caused by dynamic use of slots, changing interference per slot and link adaptation over multiple slots.

To reduce uncertainty, the global controller 15 may instruct the local AP 12-1 in step 201 to restrict the schedule for the associated EP 10 that it wants to examine, to a certain period or even to one or more fixed slots of the MAC cycle. A selection criterion for deciding whether to examine an EP is if the EP is detecting the advertisements of another AP. Then the EP is in the coverage of a neighbor AP and thus might be subject to interference.

The receiving node (e.g. EP 10) of the target AP-EP combination measures in step 202 the received bit rate at the slots at which the local AP 12-1 schedules communication with the EP 10. The EP 10 then determines in step 203 at which of these slots the bit rate is maximum (Rₘₐₓ). If the EP 10 determines in optional step 204 that for one of the scheduled slots (e.g. slot x) the bit rate is smaller than a threshold (e.g. smaller than a Rₘₐₓ), the global controller 15 determines which of the APs have been interfering in slot x and applies appropriate time-division scheduling between the local AP 12-1 and the interfering APs (e.g. neighbor AP 12-2) for the EP 10.

In step 205, the EP 10 sends an alert to the global controller 15 indicating the slot (e.g. slot x) at which the bit rate is smaller than the threshold.

Alternatively, the EP 10 may inform the global controller 15 in step 205 about the bit rate per slot and the global controller may then determine in optional step 206 for which of the scheduled slots (e.g. slot x) the bit rate is smaller than the threshold.

In some practical systems, the modulated bit rate may be determined bilaterally between the transmitter (e.g. AP or EP) and receiver (e.g. EP or AP) of the target AP-EP combination in a negotiation, where the receiver informs the transmitter about the reception quality, e.g. after receiving a test packet. That is, the receiver either successfully recovers the modulated bit payload, at its rate, or fails to recover the data. This implies that the above process most likely is extended into an iterative process in which several potentially interfering transmissions are either allowed or disallowed for a period during which transmitter and receiver can converge on a stable bit rate R before a change in the interference transmission scenario is allowed.

In an example, the AP may send an alert to the global controller indicating a slot at which the bit rate (after converging to a stable rate) is smaller than the threshold.

Alternatively, the AP may inform the global controller about the bit rate per slot and the global controller determines when the bit rate is smaller than the threshold.

In another example, bit rates per slot may be measured in multiple links. In this case, multiple EPs may each measure the received bit rate at the slots at which their AP schedules communication with its associated EP(s). Then, each EPi determines in which of these slots the bit rate is maximum, to obtain R(i,max). If for one of the scheduled slots (e.g. slot x) the bit rate is smaller than this maximum, the concerned EP may send an alert to the global controller which may then determine which of the APs have been interfering in slot x and check what bit rate was achieved by other EPs. The EP may send the alert in a message within slot x via its local AP to the global controller. It may also send the alert in a next scheduled slot via its local AP to the global controller thereby indicating that it was interfered in slot x. The global controller then applies a follow-up action by finding out which of the APs caused interference in slot x, applies appropriate time-division and coordinates the APs accordingly.

In particular, the global controller may check whether R(i,max) is larger than R(i,j)+R(j,i), in which R(i,j) is the bit rate achieved by EPi during interference from an AP associated to EPj, and R(j,i,) is the bit rate achieved by EPj during interference from an AP associated to EPi. The global controller may thereto requests the received bit rates R(i,max), R(i,j) and R(j,i).

If R(i,max) (achieved in interference free slots) exceeds the joint throughput R(i,j)+R(j,i), then the global controller may apply appropriate time-division scheduling between the local AP and the interfering AP(s) for the EP.

It is noted that in this context, a neighboring AP is an AP for which the EP (associated to a local AP) has reported the detection of its advertisement.

If only one neighbor AP was sending in time slot x, the global controller applies time-division scheduling between the local AP and that neighboring AP for the EP. If multiple APs were sending in time slot x, then the global controller applies one of the following options:
The global controller applies time-division scheduling between the local AP and all the neighboring APs that were sending in slot x for the EP and coordinates the APs accordingly.
The global controller applies time-division scheduling between the local AP and the neighboring AP (that was transmitting in slot x) with the highest advertisement signal power detected by the EP. If the EP no longer sends an alert then the time-division was successful, otherwise the global controller repeats this for the neighboring AP (that was transmitting in slot x) with the next highest advertisement detected by the EP.

The EP sends the alert with a transmission pattern that can be recognized by the neighboring APs in the coverage area as alert, or otherwise results in strong interference. The EP may do so starting e.g. halfway, or close to the end of slot x. A neighboring AP that detects this transmission pattern or a strong interference in slot x while it was also transmitting in slot x, assumes that it was interfering an EP in slot x and reports this to the global controller. The global controller then applies time-division scheduling between the local AP and the neighboring APs that report the detection of the transmission pattern or strong interference in slot x.

As indicated before, the bit rate may be determined bilaterally between transmitter (AP or EP) and receiver (EP or AP), where the receiver informs the transmitter about the reception quality. This means that an established data rate is not only available as a measurement in the receiver, but also at the transmitter. So, in case that an AP is sending to an EP in multiple slots, the AP can determine at which of these slots, the bit rate is maximum: Rₘₐₓ. If for one of the scheduled slots (slot x) the bit rate is reduced to below a threshold, e.g. smaller than αRₘₐₓ, the AP requests the global controller to apply time-division scheduling for slot x.

Thus, in the second cross-over point determination option, the interference of multiple neighboring APs can be included by applying the reduction threshold. The first and second cross-over point determination options can be combined to better handle interference of multiple neighbor APs. E.g., the first option can help to find the interfering node detected in the second option.

According to the third cross-over point determination option, a low rate test signal is used to estimate achievable interfered bit rate and non-interfered bit rate.

This shortens the reaction time compared to the second cross-over point determination option, because there is no need to stabilize the test link. Moreover, the test link can be established by using a single time slot in the MAC cycle, which enables to investigate the slots individually.

However, the system must still relate the quality of the signal reception for a slot to the source of interference.

A suitable method to establish achievable bit rates can be to transmit a low rate test signal, thus one in which, for example in case a unipolar Orthogonal Frequency Division Multiplexing (OFDM) signal is used, a robust/crude signal constellation is used, or another robust interference-tolerant coding scheme, or in which a known training signal is transmitted. This transmission is conducted with and without interference. The receiver (AP or EP) measures the SNR or error vector magnitude (EVM), i.e., the difference between the expected constellation points and the actual received signal. This allows an estimation of a minimum required distance between two constellation points, thus the achievable number of bits in the symbols.

Then, a trade-off is made whether the rate for one AP with an interference-free communication is sufficiently better than the joint throughput of this AP and other AP(s) that may be allowed to use the same time slot.

The advantage of this option compared to the second option is that with a low rate test signal, the probability to successfully decode the signal is much higher at interference than with a high rate signal, which allows to estimate the expected bit rate before the high rate signal converges to a stable rate.

The error vector mentioned above is a vector in the I-Q plane between the ideal (QAM) constellation point and the point received by the receiver. In other words, it is the difference between actual received symbols and ideal (noise and interference free) symbols. For reliable communication, these received points need to be closer to the transmitted point than to any other valid signal point. The root mean square (RMS) average amplitude of the error vector, normalized to ideal signal amplitude reference, is the EVM. The square of the EVM, thus the variance in the noise and interference deviation relative to the power in the signal, can be interpreted as one divided by the SNR. In fact, here we generalize the noise to also encompass interference.

Thereby the SNR (based on the EVM) or any similar measure of the relative strength of the perceived noise and the signal allows an estimation of a minimum required distance between two constellation points to avoid detection errors to occur, and thus provides an estimation of the achievable number of bits in the symbols. The relation between the SNR and the bit error rate performance of various modulation methods is commonly known. Many practical communication systems can select the modulation method with the highest bit rate that still achieves acceptable bit error rates.

In our disclosed approach, this is extended by a comparison of the achievable bit rate, under different conditions of interference. Preferable, a crude constellation is used for (the set of) EVM measurements, as it allows an easier calculation of the EVM during heavy interference when clouds of received points do not overlap with clouds of other points. Stronger interference conditions give lower SNR, or equivalently larger EVMs, thus only allow modulation with lower bit rates. However, prohibiting interference reduces the throughput for other users.

FIG. 21 shows schematically a processing and signaling diagram for a third cross-over point determination option based on bit rate estimation.

In step 210, the global controller 15 determines a test time slot for an AP 12-1 at which interference from a neighbor AP 12-2 occurs and instructs the AP 12-1 and its neighbor AP 12-2 accordingly in steps 211 and 212. The global controller 15 may enforce the neighbor AP 12-2 to schedule an (interfering) test signal in that slot.

It is noted that this enforcement differs from the original coordination by “constraints” in which the global controller 15 “restricts an AP” or inversely “allows an AP”, which leaves the freedom to the AP to not schedule communication in a slot when the global controller 15 allows.

In step 213, the local AP 12-1 transmit a low rate test signal to the EP 10. This transmission is conducted without and with interference (214) by the neighbor AP 12-2. In an example, the test signal may be applied in a certain time slot within a MAC cycle with interference in that time slot and in the same time slot in a following MAC cycle without interference in that time slot. In another example, the test signal may be applied in two different time slots in one MAC cycle, one time slot with interference and the other time slot without interference.

The test time slot may be an advertisement slot of the common channel (CC) of a MAC cycle.

The receiving node (EP 10) then determines in step 215 how the bit rate with interference relates to the bit rate without interference and if the ratio or the difference between them is below or above a threshold. Based on this, it informs the global controller 15 in step 217 whether or not time-division scheduling is required for this EP.

Alternatively, the local AP 12-1 may determine and compare the bit rates in optional step 215 and inform the global controller 15 in optional step 217 about the bit rate with interference and the bit rate without interference. The global controller 15 may then determine in step 218 whether time-division scheduling is needed or not for this EP and set a corresponding scheduling mode for the EP.

In another example without the AP playing an intermediate role, the EP 10 may determine if time-division is needed and may informs the global controller 15 about its decision or the EP 10 may measure the bitrates with and without interference and may informs the global controller 15 about the measurement results so that the global controller may determine if exclusive scheduling (i.e. time division) is needed.

In other examples, the EP 10 may inform the local AP 12-1 if exclusive scheduling (i.e. time division) is needed and the local AP 12-1 forwards the decision, or the EP 10 may measure the bitrates with and without interference and may inform the local AP 12-1 which may determine whether exclusive scheduling (i.e. time division) is needed and may inform the global controller 15 about the decision.

In a further example, the EP 10 may measure the bitrates with and without interference and may inform the local AP 12-1 which forwards the measurement results to the global controller 15 which may determine if exclusive scheduling (i.e. time division) is needed.

The global controller 15 coordinates the APs according to the information it receives from the EPs and/or APs by applying time-division scheduling or not via the constraints it imposes on the scheduling of the APs. If time-division scheduling for an EP is decided, the global controller may determine which neighbor transmitting node(s) contribute(s) most to the interference to act accordingly. The global controller may further determine relevant interference contributors by selectively instructing neighbor APs to schedule the test signal e.g. with the help of available parameters at the EP according to the first option. The EP thereto indicates for which neighbor AP the received advertisement has the strongest signal or alternatively indicates the received advertisement signal strengths of the neighbor APs.

The first and third cross-over point determination options provide increased certainty by deterministic assignment of test/silence slots by the global controller and coordinating the APs accordingly. They could be combined to complement each other.

A suitable method to establish achievable bit rates can be to transmit a low rate test signal, thus one in which, for example in case of a unipolar OFDM signal is used, a robust/crude signal constellation is used, or another robust interference-tolerant coding scheme, or in which a known training signal is transmitted. This transmission is conducted at slots with interference and at slots without interference. For this purpose, the test signal may be sent to an EP in the slots at which it normally sends data to compare the quality of the link for each slot. Additionally, the global controller may arrange some slots at which interference is minimal to arrange a good reference for the optimal link quality. Instead of measuring the bit rate directly as in the second cross-over point determination option, the receiver may measure the SNR or error vector magnitude (EVM), i.e., the difference between the expected constellation points and the actual received signal. This allows an estimation of the minimum required distance between two constellation points, thus the achievable number of bits in the symbols.

Then, a trade-off can be made whether the rate for one AP with an interference-free communication is sufficiently better than the joint throughput of this AP and other AP(s) that may be allowed to use the same time slot.

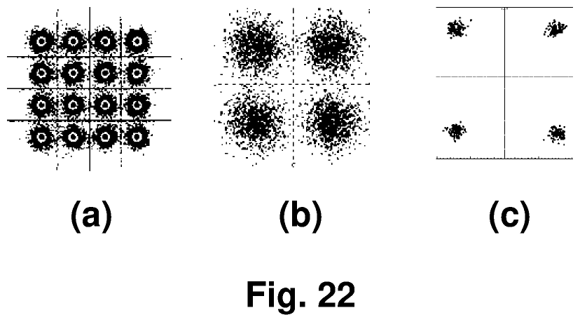

FIG. 22 shows schematically three examples (a) to (c) of signal quality in relation to different signal constellations. In the left example (a), the signal quality matches quite well with the 16 constellation points, as the measurement points are concentrated in the related areas of the constellation points. The example (b) in the middle relates to lower signal quality which can be matched to 4 constellation points only. The right example (c) would allow a higher constellation (i.e. more bits) since the clusters of measurement points are concentrated on small areas.

In the third cross-over point determination option, the AP may examine a time slot at which it normally schedules data by transmitting a test signal in that slot to estimate the achievable bit rate in that slot. In case of pronounced interference from neighbor APs, the first cross-over point determination option can be applied to find out which of the neighbor APs is the main source of interference for an EP. This can be especially relevant if the global controller does not (selectively) enforce the neighbor APs to schedule transmission for that slot and the interference then varies depending on the scheduling of the neighbor APs.

To support the global controller for such a modification, the EP may indicate for which neighbor AP the received advertisement has the strongest signal or may alternatively indicate the received advertisement signal strengths of the neighbor APs.

If the first cross-over point determination option is not supported, the global controller may be configured to block the AP with the strongest signal to the target EP first by exclusive scheduling. Then, if there is still interference, the less strong APs are blocked by exclusive scheduling until the interference is acceptable and can be tolerated. Alternatively, all neighbor APs can be blocked by exclusive scheduling and then an AP with the weakest signal may be made active again first, then the second and so on.

Alternatively, the global controller may selectively enforce a test signal per potential interfering AP to find out to what extent these APs contribute to the interference. It may select one AP per MAC cycle for a particular time slot, but it may also use multiple slots in a MAC cycle whereby for each slot a different AP is selected for interfering.

Another possibility is to integrate the third cross-over point determination option into the first cross-over point determination option by examining a time slot at which an AP normally schedules advertisements by transmitting a test signal in that slot to estimate the achievable (maximal) bit rate in that slot. The test signal may even be the advertisement frame, since such a frame is anyhow transmitted with a low data rate to enable neighbor nodes to decode them also at a weak reception of the signal. Further, this advertisement frame can be chosen to be interference-free, which facilitates the determination of the maximal bit rate and (temporally) can be chosen to be interfered, which facilitates the determination of the interfered bit rate. The global controller may also choose for each AP an interference-free advertisement slot and another advertisement slot at which it examines interference.

For determining the cross-over point for upstream transmission (i.e. from EP to AP), a similar approach can be taken as for downstream transmission (AP to EP), whereby each AP measures the received signal strength of the EPs advertisements in the first cross-over point determination option. Different is that the EPs need not have a fixed position like APs but may move and more EPs may occur within a certain area than APs.

In general, office users of optical wireless communication (OWC) will be stationary for longer periods of time and as a result intermittent re-calibration may be called for. Alternatively, in the event of an unexpected increase in retries, resulting from excessive interference or upon detection of motion using motion sensors, such as accelerometers, gyroscopes, magnetometers, and/or other motion-sensors, the EP may report such event to the AP and/or global controller in order to fallback to interference-free scheduling for that EP.

In case multiple EPs are close together, there may be too many EP advertisements in the common channel per MAC cycle, which could increase the delay of the interference handling for applying the first cross-over point determination option. This might be a valid reason to fall back to interference-free scheduling for the EP.

The second cross-over point determination option may be improved in that each EP advertises its presence on request by the global controller or by the AP. If the global controller or the AP detects a reduction of the upstream bit rate of an EP for time slot x, it requests this EP to advertise its presence. This then enables the second and third options of the second cross-over point determination option for the case that multiple EPs cause upstream interference.

To summarize, what has been described is a mechanism to improve system performance in an optical wireless communication system by examining whether time slots in time channels are scheduled for exclusive use or could be utilized for parallel communication. The examination is based on a cross-over point from tolerating interference to applying time division. A reserved period for each access point is defined within its assigned time channel, which is exclusively reserved for communication with its endpoint(s).

This reduces the communication overhead and keeps freedom of adapting slot-scheduling in the exclusive period at the cost of some performance reduction. To minimize this performance reduction, the size of the reserved period can be adapted to the actual need based on the traffic demand for exclusive use and non-exclusive use.

While the invention has been illustrated and described in detail in the drawings and foregoing description, such illustration and description are to be considered illustrative or exemplary and not restrictive. The invention is not limited to the disclosed LiFi-based embodiments but may be applied to all kinds of optical wireless networks with interference handling functionality that may be provided centrally or distributed (e.g. part of a global controller functionally may be logically comprised in access points).

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

A single unit or device may fulfill the functions of several items recited in the claims. The mere fact that certain measures are recited in mutually different dependent claims does not indicate that a combination of these measures cannot be used to advantage.

The described operations like those indicated in FIGS. 6, 8 to 13 and 18 to 21 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A system for controlling communication for interference handling in an optical wireless communication, OWC, network, wherein the system comprises:
an OWC endpoint arranged to determine first and second link qualities of an optical link between the endpoint and an OWC access point, the first link quality with interference resulting from a transmission by an OWC neighbor access point and the second link quality without interference from transmissions by any OWC neighbor access point;
the access point arranged to receive the determined link qualities from the endpoint; to determine a neighbor interference power representing the endpoint received signal power from the neighbor access point and a cross-over point based on the received determined link qualities, the cross-over point representing an interference threshold for interference tolerance, such that when said neighbor interference power is above the cross-over point, said neighbor interference is not tolerated and the access point is arranged to decide to use a time slot for communication between the access point and the endpoint exclusively, and when said neighbor interference power is below the cross-over point interference, said neighbor interference may be tolerated and the access point is arranged to decide to use a time slot for communication between the access point and the endpoint non-exclusively; and
a network controller arranged to receive from the access point a decision as to whether a time slot in the pre-reserved time channel used for communication between the access point and the endpoint is selected for exclusive use or for non-exclusive use and to schedule the time slot in the pre-reserved time channel used for communication between the access point and the endpoint respecting the selected exclusive use or non-exclusive use.

2. An optical wireless communication, OWC, endpoint for use associated with an OWC access point, the endpoint comprising an apparatus for controlling communication for interference handling in an OWC network, wherein the apparatus is configured:
to determine a first and second link qualities of an optical link between the access point and the endpoint, the first link quality with interference resulting from a transmission by an OWC neighbor access point and the second link quality without interference from transmissions by any OWC neighbor access point;
the endpoint configured to determine a neighbor interference power representing the endpoint received signal power from the neighbor access point and a cross-over point based on the determined link qualities, the cross-over point representing an interference threshold for interference tolerance, such that when said neighbor interference power is above the cross-over point, said neighbor interference is not tolerated, and when said neighbor interference power is below the cross-over point said neighbor interference may be tolerated; and
and wherein the apparatus is further configured:
to decide how a time slot in a pre-reserved time channel is used for communication between the access point and the endpoint, by selecting to use the time slot for communication between the access point and the endpoint exclusively for the access point and the endpoint when said neighbor interference is above the cross-over point and to use the time slot for communication between the access point and the endpoint non-exclusively when said neighbor interference is below the cross-over point; and
to send the decision to a scheduling function.

3. The endpoint of claim 2, wherein the apparatus is configured to determine the first and second link quality by determining a bit rate of a time slot with interference from the neighbor device and a bit rate of a time slot with without interference from any neighbor device.

4. The endpoint of claim 2, wherein the apparatus is configured to use at least one silent time slot during which no communication takes place for estimating noise power.

5. The endpoint claim 2, wherein the apparatus is configured to measure the link quality between the access point and the end point in a test time slot where neighbor access points do not schedule any communication.

6. An optical wireless communication, OWC, access point for providing access for associated OWC endpoints to an OWC system, the access point comprising an apparatus for controlling communication for interference handling in an OWC network, wherein the apparatus is configured:
to determine a first and second link qualities of an optical link between the access point and the endpoint, the first link quality with interference resulting from a transmission by a neighbor OWC endpoint and the second link quality without interference from transmissions by any neighbor OWC endpoint;
the access point configured to determine a neighbor interference power representing the access point received signal power from the neighbor endpoint and a cross-over point based on the determined link qualities, the cross-over point representing an interference threshold for interference tolerance, such that when said neighbor interference power is above the cross-over point interference is not tolerated, and when said neighbor interference power is below the cross-over point said neighbor interference may be tolerated; and
and wherein the apparatus is further configured:
to decide how a time slot in a pre-reserved time channel is used for communication between the access point and the endpoint, by selecting to use the time slot for communication between the access point and the endpoint exclusively for the access point and the endpoint when the neighbor interference is above the cross-over point and to use the time slot for communication between the access point and the endpoint non-exclusively when said neighbor interference is below the cross-over point; and
to send the decision to a scheduling function.

7. An optical wireless communication, OWC, access point for providing access for associated OWC endpoints to an OWC system, the access point comprising:
a receiver arranged to receive first and second link qualities of an optical link between the access point and an associated endpoint, the first link quality with interference resulting from a transmission by a neighbor OWC endpoint and the second link quality without interference from transmission by any neighbor OWC endpoint;
the access point arranged to determine a neighbor interference power representing the access point received signal power from the neighbor endpoint and a cross-over point based on the received link qualities, the cross-over point representing an interference threshold for interference tolerance, such that when said neighbor interference power is above the cross-over point said neighbor interference is not tolerated, and when said neighbor interference power is below the cross-over point, said neighbor interference may be tolerated; and
the access point further comprising:
a scheduler arranged to
determine how a time slot in a pre-reserved time channel is used for communication between the access point and the endpoint, by selecting to use the time slot for communication between the access point and the endpoint exclusively for the endpoint when said neighbor interference is above the cross-over point; and to use the time slot for communication between the access point and the endpoint non-exclusively when said neighbor interference is below the cross-over point; and
schedule the time slot in the pre-reserved time channel used for communication between the access point and the endpoint respecting the selected exclusive use or non-exclusive use.

8. A distributed or centralized network controller for providing a scheduling function for interference handling in an optical wireless communication, OWC, system comprising an OWC access point and an associated OWC endpoint (10), the network controller comprising:
a receiver arranged to receive first and second link qualities of an optical link between the access point and the endpoint, the first link quality with interference resulting from a transmission by an OWC neighbor device of the access point or the endpoint, and the second link quality without interference resulting from a transmission by any OWC neighbor device of the access point or the endpoint;
the network controller arranged to determine a neighbor interference power representing the received signal power from the neighbor device and a cross-over point based on the received link qualities, the cross-over point representing an interference threshold for interference tolerance, such that when said neighbor interference power is above the cross-over point, said neighbor interference is not tolerated and when the said neighbor interference power is below the cross-over point, said neighbor interference may be tolerated; and
the network controller further comprising:
a scheduler arranged to
determine how a time slot in a pre-reserved time channel is used for communication between the access point and the endpoint, by selecting to use the time slot for communication between the access point and the endpoint exclusively for the access point and the endpoint when said neighbor interference is above the cross-over point; and to use the time slot for communication between the access point and the endpoint non-exclusively when said neighbor interference is below the cross-over point and
schedule the time slot in the pre-reserved time channel used for communication between the access point and the endpoint respecting the selected exclusive use or non-exclusive use.

9. The network controller of claim 8, wherein the network controller is configured to provide at least one of a silent time slot for noise measurement and a test time slot at which no detected neighbor access point is transmitting.

10. The network controller of claim 9, wherein the test time slot is an advertisement slot on a common channel of a transmission frame.

11. The network controller of claim 8, wherein the network controller is configured to determine a test time slot for an access point at which interference from a neighbor access point occurs and to enforce the neighbor access point to schedule an interfering test signal in the test time slot.
